(19) United States
(12) Patent Application Publication
(10) Pub. No.: US 2003/0154138 A1
(43) Pub. Date: Aug. 14, 2003

(54) Identification verification system and method

(76) Inventors: John Phillips, San Francisco, CA (US); Ming Tao, Arlington, VA (US); Kim Haward Ulrey, Riegelsville, PA (US); Igor Kyrylenko, Arlington, VA (US); Jeff Siebeneichen, Germantown, MD (US); Ellian Jen, Germantown, MD (US); Laurel Miller, Falls Church, CA (US); J. Blair Richardson, Falls Church, VA (US)

Correspondence Address: PILLSBURY WINTHROP, LLP, P.O. BOX 10500, MCLEAN, VA, 22102, US

(21) Appl. No.: 10/324,083

(22) Filed: Dec. 20, 2002

Related U.S. Application Data
(60) Provisional application No. 60/341,865, filed on Dec. 21, 2001.

(51) Int. Cl. G06F 17/60

(52) U.S. Cl. 705/26

(57) ABSTRACT

Methods and apparatus to verify information, including a method of verifying information comprising receiving user-supplied information from a user interested in obtaining services or products wherein the user-supplied information includes a user government identification number containing decipherable information regarding the identity of the user, and additional user identifying information. A method further including analyzing the government identification number including determining the issuing jurisdiction of the government identification number, deciphering information from the government identification number, and verifying the validity of the government identification number. A method also including retrieving confirming-information from a database relevant to the user-supplied information, comparing the confirming-information to the user-supplied information to verify the accuracy of the user-supplied information, and permitting or denying access to the user for the user-desired services or goods.

This application claims the benefit of U.S. Provisional Application Serial No. 60/341,865, filed on Dec. 21, 2001, the entire contents of which are hereby incorporated herein by reference thereto.

### COPYRIGHT NOTICE

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### FIELD OF THE INVENTION

The present invention, in certain respects, relates to information verification. In other respects, the present invention relates to computer systems and methods for information verification.

### BACKGROUND OF THE INVENTION

Certain independently acting systems exist that are used to acquire information or to verify information. U.S. Pat. No. 5,946,406 to Frink et al.; 6,055,513 to Katz et al.; 5,892,824 to Beatson et al.; 6,002,783 to Obata; 5,974,161 to York; 5,647,017, 5,544,255, 6,064,751, and 6,091,835 to Smithies et al,; 5,367,573 to Quimby; 4,805,222 to Young; 6,263,447, 6,321,339, and 6,282,658 to French et al.; 6,335,688 to Sweatte; and 6,463,416 to Messina disclose such systems, all of which are incorporated herein by reference thereto, in their entirety, respectively.

### SUMMARY OF THE INVENTION

The present invention is provided to improve upon information verification systems and methods. More specifically, improved methods are presented including a method of verifying information comprising receiving a government identification number sent by a remote user via a user information vehicle to a local analyzer, the remote user being interested in obtaining services or products, the government identification number containing decipherable information regarding the identity of the remote user; analyzing the government identification number including, determining the issuing jurisdiction of the government identification number, deciphering information from the government identification number, and verifying the validity of the government identification number; and notifying the remote user of the results of the verification of the government identification number and permitting or denying access to the remote user for the remote user-desired services or goods.

Another object of the invention is to provide a computer-readable medium encoded with a program for verifying information, said program comprising: receiving a government identification number sent by a remote user via a user information vehicle to a local analyzer, the remote user being interested in obtaining services or products, the government identification number containing decipherable information regarding the identity of the remote user; analyzing the government identification number including, determining the issuing jurisdiction of the government identification number, applying an issuing jurisdiction algorithm to the government identification number to decipher information from the government identification number, and verifying the validity of the government identification number; and notifying the remote user of the results of the verification of the government identification number and permitting or denying access to the remote user for the remote user-desired services or goods.

Another object of the invention is to provide a method of verifying information comprising: receiving user-supplied information from a user interested in obtaining services or products, the user-supplied information including: a user government identification number containing decipherable information regarding the identity of the user, and additional user identifying information; analyzing the government identification number including, determining the issuing jurisdiction of the government identification number, deciphering information from the government identification number, and verifying the validity of the government identification number; retrieving confirming-information from a database relevant to the user-supplied information; comparing the confirming-information to the user-supplied information to verify the accuracy of the user-supplied information; and permitting or denying access to the user for the user-desired services or goods.

Another object of the invention is to provide a computer-readable medium encoded with a program for verifying information, said program comprising: receiving user-supplied information from a user interested in obtaining services or products, the user-supplied information including: a user government identification number containing decipherable information regarding the identity of the user, and additional user identifying information; analyzing the government identification number including, determining the issuing jurisdiction of the government identification number, deciphering information from the government identification number, and verifying the validity of the government identification number; retrieving confirming-information from a database relevant to the user-supplied information; comparing the confirming-information to the user-supplied information to verify the accuracy of the user-supplied information; and permitting or denying access to the user for the user-desired services or goods.

Another object of the invention is to provide a method of verifying information comprising: receiving user-supplied information from a user interested in obtaining services or products, the user-supplied information including: a user government identification number containing decipherable information regarding the identity of the user, and additional user identifying information; analyzing the government identification number including, determining the issuing jurisdiction of the government identification number, deciphering information from the government identification number, and verifying the validity of the government identification number; retrieving confirming-information from a database relevant to the user-supplied information; comparing the confirming-information to the deciphered information from the government identification number to further verify the identity of the user; and permitting or denying access to the user for the user-desired services or goods.

Another object of the invention is to provide a computer-readable medium encoded with a program for verifying information, said program comprising: receiving user-supplied information from a user interested in obtaining services or products, the user-supplied information including: a user government identification number containing decipherable information regarding the identity of the user, and additional user identifying information; analyzing the government identification number including, determining the issuing jurisdiction of the government identification number, deciphering information from the government identification number, and verifying the validity of the government identification number; retrieving confirming-information from a database relevant to the user-supplied information; comparing the confirming-information to the deciphered information from the government identification number to further verify the identity of the user; and permitting or denying access to the user for the user-desired services or goods.

Another object of the invention is to provide a method of verifying information comprising: receiving identifying information from a user interested in obtaining information from an Internet Web site; receiving information on the user from a government identification number; determining whether the user is qualified to access the Internet Web site by comparing the information received regarding the user against predetermined standards for obtaining the desired information; and notifying the Internet Web site of the results of the determination of the user's qualification.

Another object of the invention is to provide a computer-readable medium encoded with a program for verifying information, said program comprising: receiving identifying information from a user interested in obtaining information from an Internet Web site; receiving information on the user from a government identification number; determining whether the user is qualified to access the Internet Web site by comparing the information received regarding the user against predetermined standards for obtaining the desired information; and notifying the Internet Web site of the results of the determination of the user's qualification.

Other objects will be apparent from the written description and the appended claims and drawings.

### BRIEF DESCRIPTION OF THE DRAWINGS

The present invention is further described in the detailed description with- follows, by reference to the noted drawings by way of non-limiting exemplary embodiments, in which like reference numerals represent similar parts throughout the several views of the drawings, and wherein:

FIG. 1 illustrates a verification method in accordance with an embodiment of the invention;

FIGS. 2-6 illustrate various embodiments of the method illustrated in FIG. 1;

FIG. 7 illustrates a verification method in accordance with an embodiment of the invention;

FIGS. 8-14 illustrate various embodiments of the method illustrated in FIG. 7;

FIG. 15 illustrates a verification method in accordance with an embodiment of the invention;

FIG. 16 illustrates an embodiment of the method illustrated in FIG. 15;

FIG. 17 illustrates a verification method in accordance with an embodiment of the invention;

FIGS. 18 and 19 illustrate various embodiments of the method-illustrated in FIG. 18;

FIGS. 20-25 illustrate various verification methods in accordance with various embodiments of the invention; and

FIG. 26 illustrates an example of a URL format for supplying information to the analyzer of the embodiments of the invention.

### DETAILED DESCRIPTION OF THE PREFERRED EMBODIMENTS

As seen in the Figures, the illustrated embodiments of the invention provide apparatus and methods for verifying the identity of an individual who wishes to access certain services or certain products. The preferred embodiment of the invention includes utilization of a government identification number (GID number), wherein a potential user of the desired goods and services presents his or her GID number for access to the goods or services. Additional identifying information can be provided along with the GID number. The GID number is analyzed to determine its authenticity. To this end, the jurisdiction issuing the GID number is identified and the appropriate jurisdiction-specific algorithm is performed on the GID number to verify its authenticity and to extract information about the user. Government databases are accessed to confirm the accuracy of the additional identification information supplied by the user. If the GID number is confirmed to be valid and the additional identifying information is confirmed to be accurate, approval for the user to access the goods or services is granted and the appropriate steps are taken to supply the user with the goods or services. If the GID number is found not to be authentic or the additional information supplied is determined not be accurate, user access is denied. Examples of goods include government-restricted items such as cigarettes. Examples of services include access to Internet Web sites and access to an airport or an airplane through airport security.

A GID number is a number issued to an individual by a government for identification purposes. The number may take various forms and be made of various characters. The GID number contains information about the individual, such as age, nationality, date of birth, etc. The information on the GID number may be coded such that the information is not readily decipherable. The GID number may also have information that is readily decipherable. However, the individuals or entity verifying the identity of the holder of the GID number require assistance in deciphering the GID number for the information contained therein if the verifier wishes to use the GID number to verify the GID number or to verify the identity of the user. Additionally, the GID number may be supplied on a government identification card. The contents and form of the card can also be verified for accuracy.

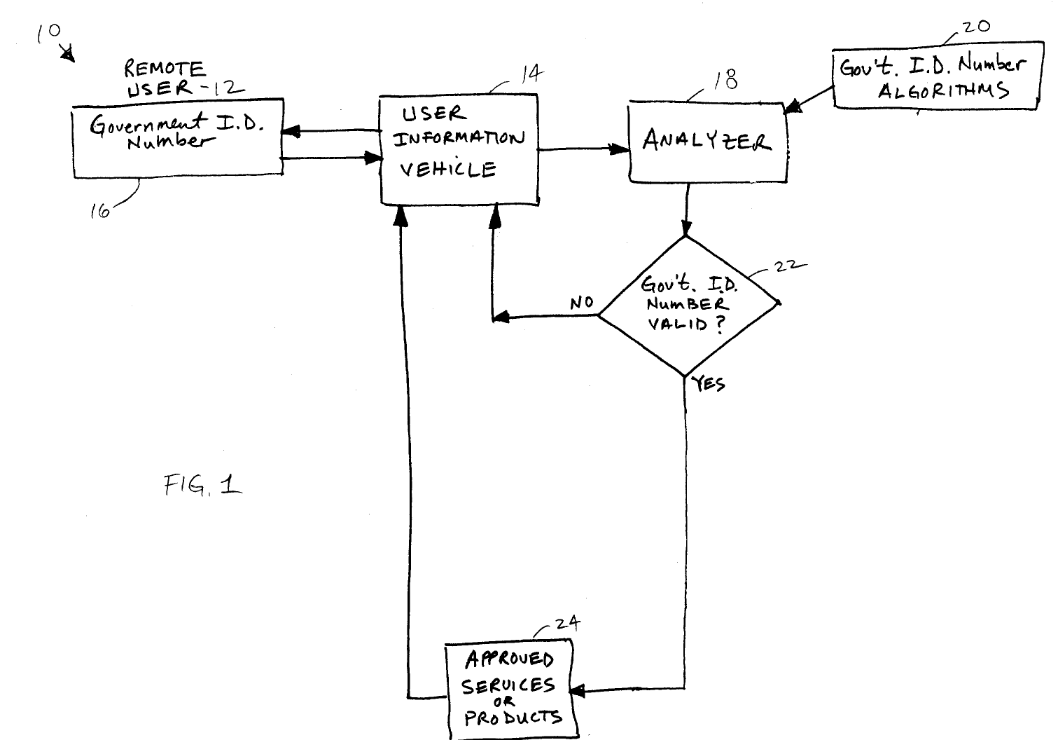

FIG. 1 illustrates a verification system 10 in accordance with a first embodiment of the invention wherein a remote user 12 desires access to goods and services that are remote from the user. That is, the user 12 is not personally located where the goods and services are located and requires the use of a user information vehicle 14 to transmit the user information to the authority that will verify the users information 16. In this instance, the GID number is transmitted from the remote location to an analyzer 18. Although the user information vehicle can forward the GID number to the analyzer 18 in various ways, as mentioned below, at the analyzer 18, the GID number is entered into the computer servers controlling the analyzer 18, as the analyzer is a system of computers that analyze the GID number. The analyzer is supported by a database 20 or a system of databases containing GID number information and algorithms for deciphering GID numbers for each desired GID number-issuing jurisdiction. Once at the analyzer 18, the GID number is initially analyzed to determine the jurisdiction that issued the GID number. Once that is determined, the analyzer selects the appropriate algorithm for applying to the supplied GID number in order to decipher the GID number and the information embedded therein.

For example, the analyzer 18 can analyze the length and contents of the identification number issued by the governmental agency to ascertain such things as the user's 12 identity, age, nationality, place of birth, relatives, length or residence, other identifying personal characteristics or eligibility under governmental or commercial regulations to operate a motor vehicle, possess a firearm, transit national borders or acquire products or services intended for adults. The information capable of extraction from the GID number is dependent upon the information contained within the number. Thus, the analyzer 18 obtains the government identification number and then interprets its contents to obtain the information embedded within the GID number 16 regarding the individual to which the identification number relates.

The GID number 16 may, for example, be a dedicated government identification number issued purely for identification or it may be a number that is also associated with some other form of government identification, such as a driver's license. The GID numbers contain embedded information. For example, a State of Montana's driver's license has thirteen digits. The first two digits represent the month of birth (e.g., 06), the third, fourth, and fifth digits can be any numbers (e.g., 021). Digits in the sixth through ninth spaces are the birth year (e.g., 1999). The tenth and eleventh digits can be any numbers (e.g., 04). The twelfth and thirteenth digits are the day of birth, that is, the day of the month on which the GID number holder was born (e.g., 13). Although some state and jurisdictions may have a common format for GID numbers, most states and countries have their own format. For example, in Germany, the national identification card has four groupings—a first group of eleven characters, a second group of seven characters, a third group of seven characters, then a fourth group consisting of a single control number. The first 11 are ten numeric digits then an alpha digit (e.g., 0123456789A). The next seven digits are the year of birth (two digits), the birth month (two digits), the day of birth (two digits) and the last digit represents gender—0 for female and 2 for male (e.g., 6501200). For the second group of seven digits, the expiration date year is the first two digits, the expiration month is the next two digits and the expiration day is two digits, and the last digit is a control number (e.g., 0205153). Thus, the capability to receive and analyze and verify any of a number of state and national GID numbers/cards requires the ability to decipher each of the numerous formats for each government's identification number.

In building the algorithm database 20, the format for each desired jurisdiction, whether it be local, state, federal, national, or other, is obtained and an algorithm is developed for each jurisdiction so that any GID number from a respective jurisdiction can be reviewed and deciphered to extract the information embedded therein. Additionally, the analyzer may utilize an algorithm that relies upon the distinguishing characteristics of each jurisdiction to analyze a given GID number to first determine the issuing jurisdiction. Then, once an issuing jurisdiction is determined, the GID number can be processed by the appropriate information-extracting algorithm for that identified jurisdiction in order to decipher the GID number and extract the information embedded therein.

The algorithm for each jurisdiction can not only decipher the GID number and extract the information, but it can also determine if the format of the GID number is proper for the given jurisdiction. Thus, upon receipt of a GID number 16, the analyzer 18 can check the format of the GID number 16 and verify that all of the information is in the correct format 22. For example if a Montana driver's license with a GID number is presented, or if a GID number 16 from a Montana driver's license is supplied, and the GID number 16 only has 8 digits, the algorithm's investigation of the GID number will determine that GID number is missing five digits since Montana's license should have thirteen digits. Thus, since the format of the GID number 16 is incorrect, the user 12 is denied access. However, if the format is correct and if requiring merely the correct format for a GID number is the standard for approving or denying access to the goods and services, access to the goods and services is approved 24. Another example of an algorithm checking the GID number involves the algorithm extracting the date of birth from a GID number. If the GID number was presented from a driver's license and the age extracted from the GID number 16 indicates that the license holder is younger than the legal age in the jurisdiction of the driver's license to drive, the algorithm would notify the Web site 30 or other provider that the format is incorrect and that access is denied. The algorithm database 20 may be local to analyzer 18 and be directly connected thereto, or the algorithm database 20 may be remote from the analyzer 18 and connected thereto via an Internet connection.

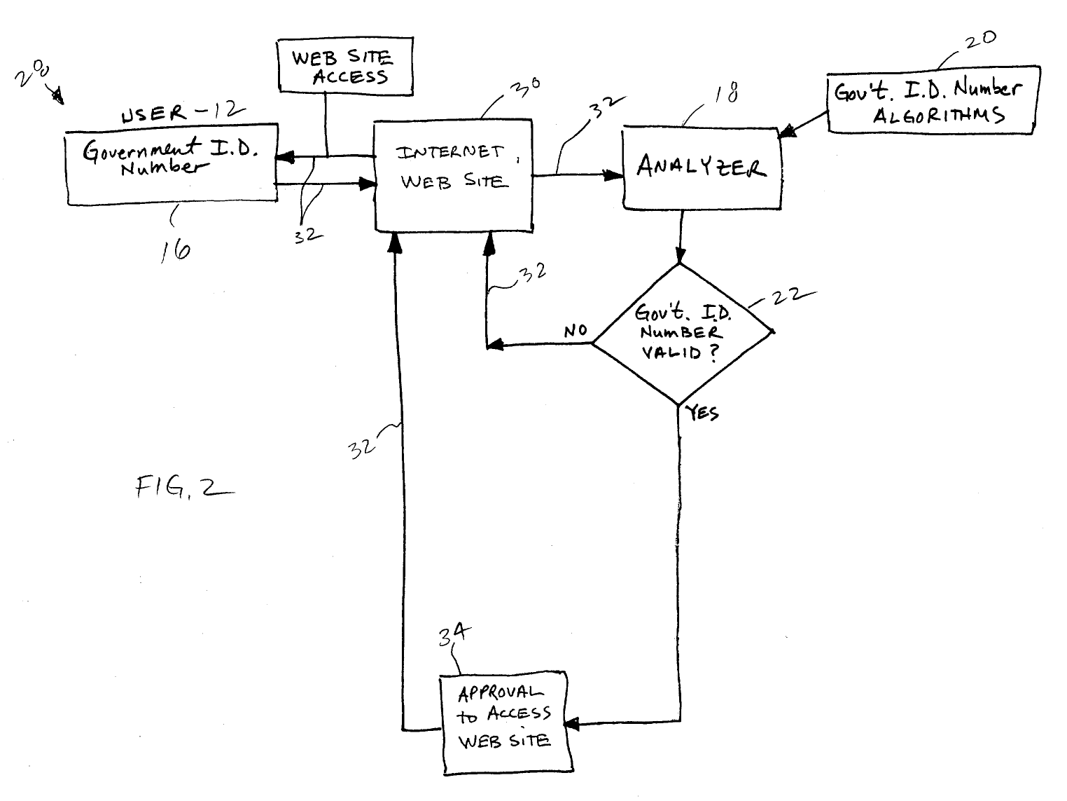

There are numerous examples of providing access to goods and services to a remote user 12 after verification of a GID number. For example, FIG. 2 illustrates one application of system 10 for controlling access to an Internet Web site 30. The system 28 of FIG. 2 enables the user 12, through the user's 12 own computer, to access Web site 30 via the Internet 32. The Web site 30 asks the user 12 for the user's GID number 16. The user's GID number 16 is entered into the user's computer via any appropriate manner such as typing or scanning a government identification card (ID card). The GID number is sent via appropriate Internet systems, such as a modem, to the Web site 30. The Web site 30 then forwards the GID number to the analyzer 18 either by the Internet 32 if the analyzer server 18 is remote from the Web site 30 or directly to the analyzer server 18 if the analyzer server is local to the Web site server 30. The GID number is then processed as set forth above and approval 34 for access to the Web site 30 is forwarded to the Web site 30 so that the user 12 can then access the Web site 30 via the Internet 32.

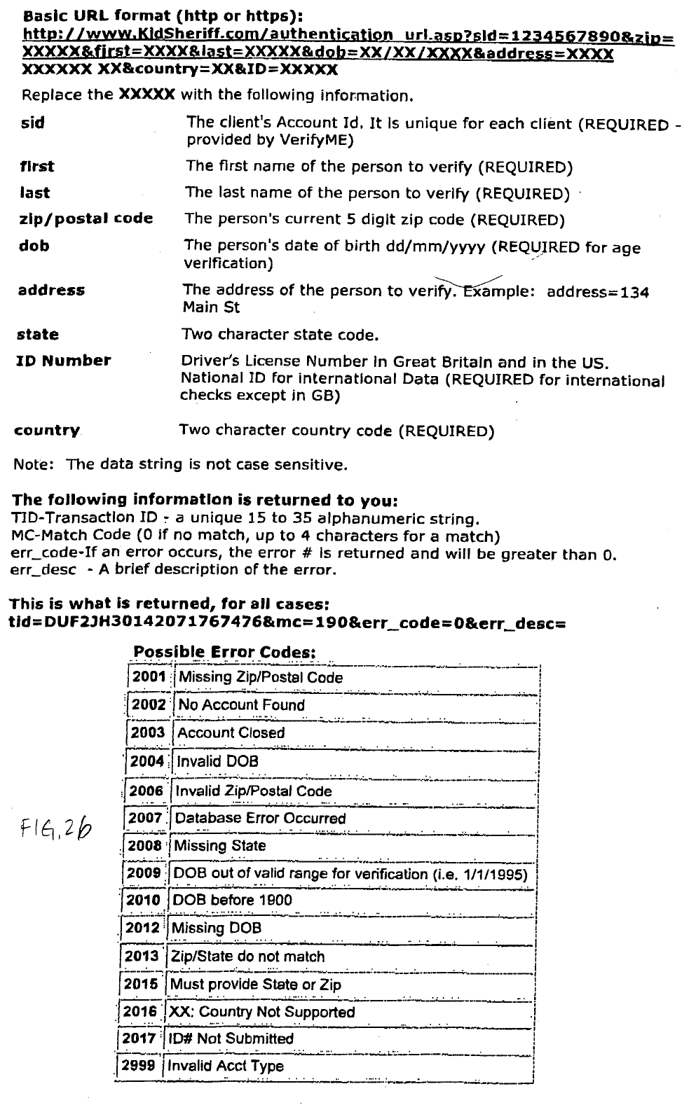

As described in more detail below, the Web site 30 can provide the user information 16 via the Internet using standard hypertext transfer protocol and a URL call with a data string for instantaneous matches between the information supplied to the analyzer 18 and the analysis performed by the analyzer 18. A sample URL string is shown in FIG. 26. The server of the analyzer 18 can accept the URL with the information 16 and may return a verification match code. The match code can be based on the criteria that has been determined by the Web site 30 manager for the level of establishing a match between the user information 12 and its verification in analyzer 18. If the verification is made and approval is granted to the user to access the goods and services, the match is recorded in the analyzer 18 and the “permit” match code is delivered to the Web site 30. If no match is made, that is, the supplied information 16, 116 does not match any of data retrieved by the analyzer 18 user 12 access can be denied or a notification can be sent out that merely confirms receipt of the information 16, 116.

When the user 12 provides the information 16 to the Web site 30, the user may submit the information and the Web site 30 constructs the URL string and sends it to the analyzer 18 for processing. The method for calling the URL within the server-side script may vary depending on the language used by the user's program. There may be no need for specific software to be installed on the user's computer. The Web site's 30 application code can make the call to the analyzer 18 using the syntax provided. The manner of making the call can be dependent upon the Web site 30 server. Thus, the Web site 30 and the user 12 can operate effectively with analyzer 18 without necessarily providing a specific operating system to the user 12 or the Web site 30.

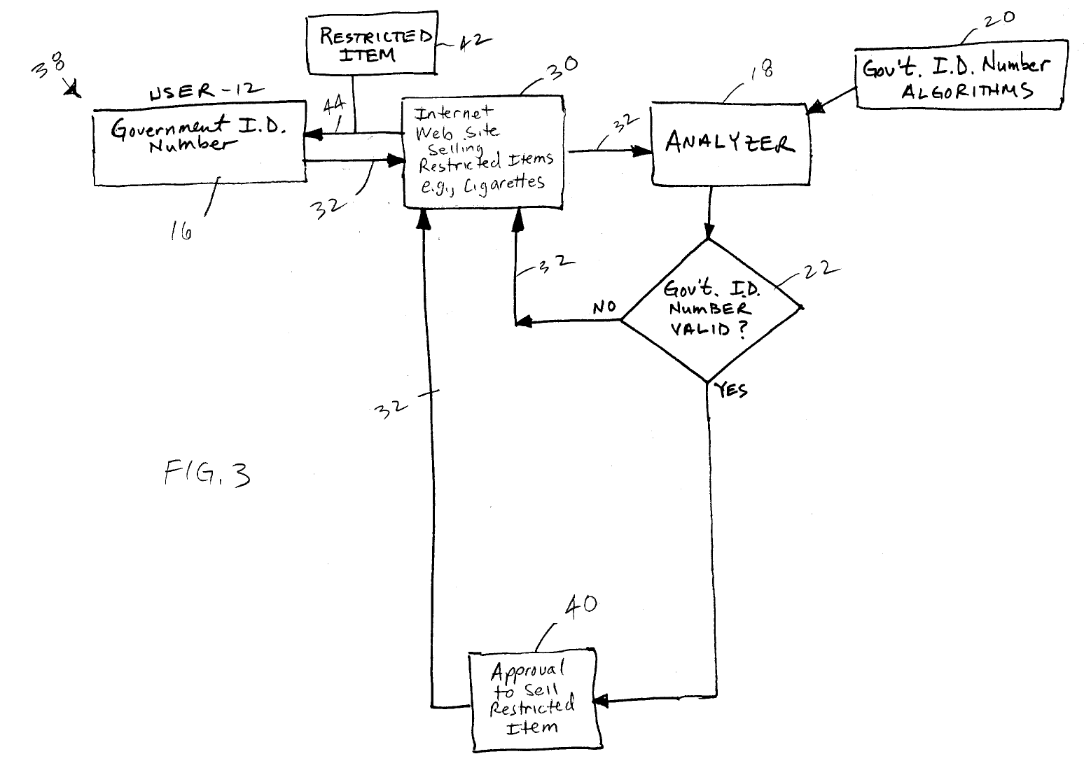

FIG. 3 illustrates a system 38 for permitting the user 12 to purchase items over the Internet such as government restricted items like cigarettes that, due to government laws, can only be sold to certain individuals within the general population. In the case of cigarettes, they can not be sold to minors. Thus, a verification of the age of the user 12 attempting to purchase cigarettes must be determined. Since the user is remote from the cigarettes, a GID number 16 can be supplied for identification purposes. System 10 can provide this verification through a check of the GID number of the user 12. As seen in FIG. 3, the process is substantially similar to that of FIG. 2 except that instead of the approval being permitting the user to access Web site 30, in system 38, the approval 40 provides approval to complete the sale of the restricted item 42, and notifies the appropriate selling and delivering entity that it can proceed with the forwarding of the restricted item 42 by appropriate delivery mechanism 44, such as postal mail delivery.

The embodiment of FIG. 3 can also be adapted to a situation where the restricted item 42 is merely a package delivered by a gatekeeper who facilitates the process. Instead of the user 12 directly accessing the Internet 32, a mobile individual who is delivering items 42 personally delivers the package 42 directly to the remote user 12. But prior to completing delivery, the gatekeeper requests the GID number 16 and/or additional identifying information such as information 116 described below, and the gatekeeper forwards the information received from the user 12 via, for example, a mobile, handheld wireless electronic device that supplies the information 16 and/or 116 via a wireless phone connection or wireless Internet connection to the analyzer 18 either directly or through Internet Web site 30. After the information 16, 116 is analyzed by analyzer 18, a wireless communication from the analyzer 18 to the mobile gatekeeper 182 either directly or through Web site 30 could permit the gatekeeper to deliver the item. One example of this application would be a express package mail delivery system.

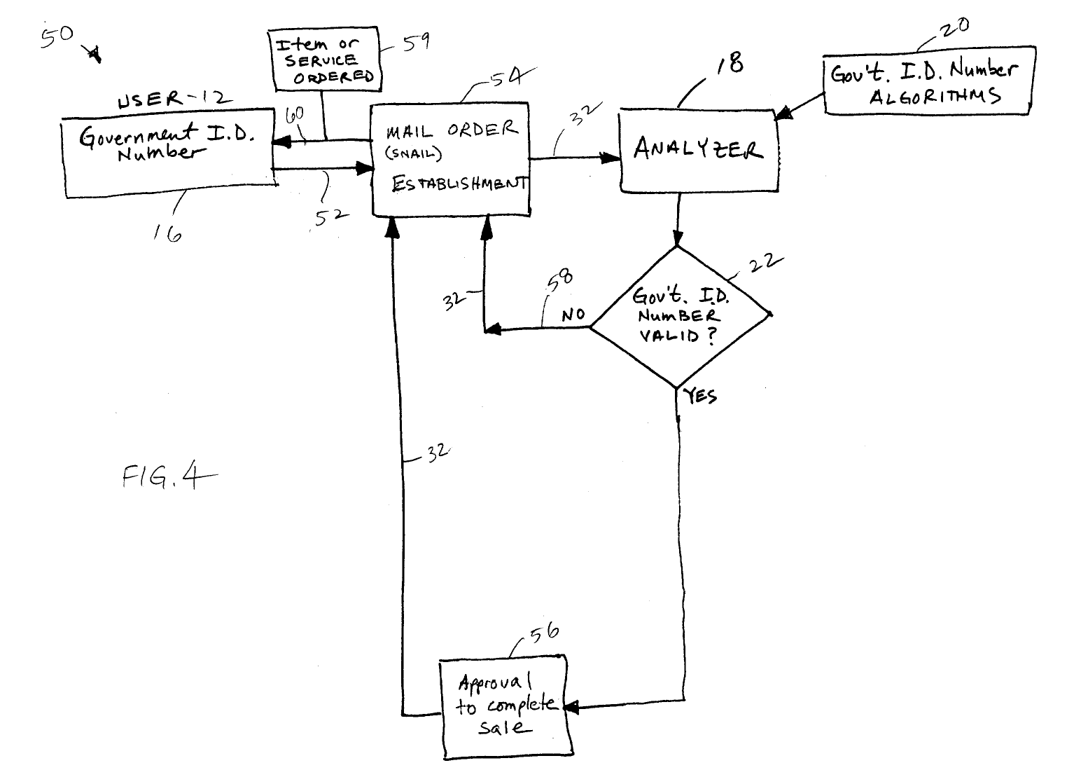

FIG. 4 illustrates one application of system 10 for permitting the user 12 to purchase items or services remotely through the use of regular postal mail, also known as “snail” mail. The items may include government restricted items like cigarettes. System 50 can provide this verification through a check of the GID number of the user 12. As seen in FIG. 4, the process is substantially similar to that of FIG. 3 except that instead of the user 12 providing the user's GID number 16 to analyzer 18 via the Internet, the remote user 12 provides the user's GID number 16 in a piece of regular postal mail via a postal mail delivery system 52 to a mail order establishment 54. The GID number 16 is then provided to the analyzer 18 for analysis as set forth above. If the establishment 54 receiving the GID number 16 is remote from the analyzer 18, the GID number 16 can be forwarded to the analyzer 18 in any appropriate manner. For example, the GID number 16 could be typed or scanned into a computer at the establishment 54 and sent via the Internet 32 to the analyzer computer server 18. As another example, the GID number 16 could be sent via mail or fax to the manager of analyzer 18 by the user 12 or by the establishment 54. The GID number 16 could then be manually entered in to a computer directly or remotely connected to the analyzer server.

The GID number 16 can then be processed as set forth above to approve 56 or deny 58 the user's 12 request. Approval or denial can be sent back to the establishment via the Internet 32 or other notifying mechanism such as postal mail. Upon approval, the establishment 54 can forward the goods and services 59 via appropriate delivery system 60.

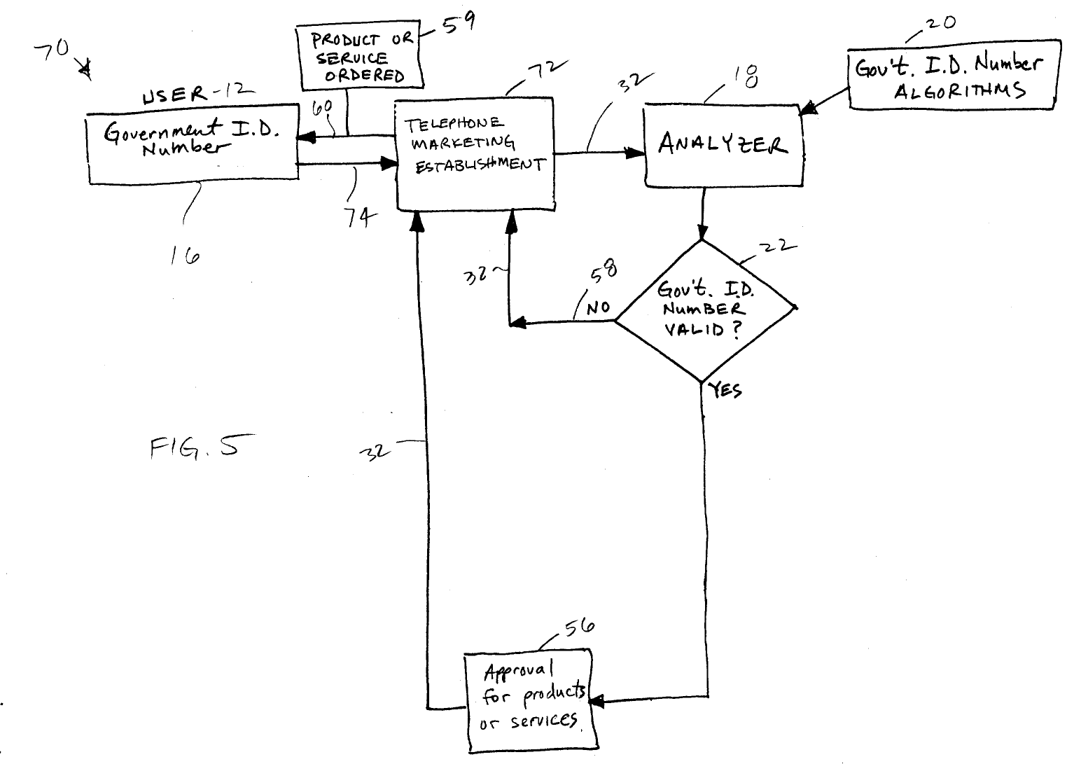

FIG. 5 illustrates a system 70 for permitting the remote user 12 to purchase items or services remotely through the use of a telephone call. The items may include government restricted items like cigarettes. System 70 can provide this verification through a check of the GID number of the user 12. The process of FIG. 5 is substantially similar to that of FIG. 4 except that instead of the user 12 providing the user's GID number 16 via the regular postal mail to a mail order establishment 54, the user 12 provides the user's GID number 16 to a telephone marketing establishment 72 via a telephone call delivery system 74 such as a land line call or a cell phone call. The GID number 16 is then provided to the analyzer 18 for analysis as set forth above. If the establishment 72 receiving the GID number 16 is remote from the analyzer 18, the GID number 16 can be typed or scanned into a computer at the establishment 72 and sent via the Internet 32 to the analyzer computer server 18. The GID number 16 can then be processed as set forth above to approve 56 or deny 58 the user's 12 request. Approval or denial can be sent back to the establishment 72 via the Internet 32 or other notifying mechanism such as postal mail. Upon approval, the establishment 74 can forward the goods and services 59 via appropriate delivery system 60.

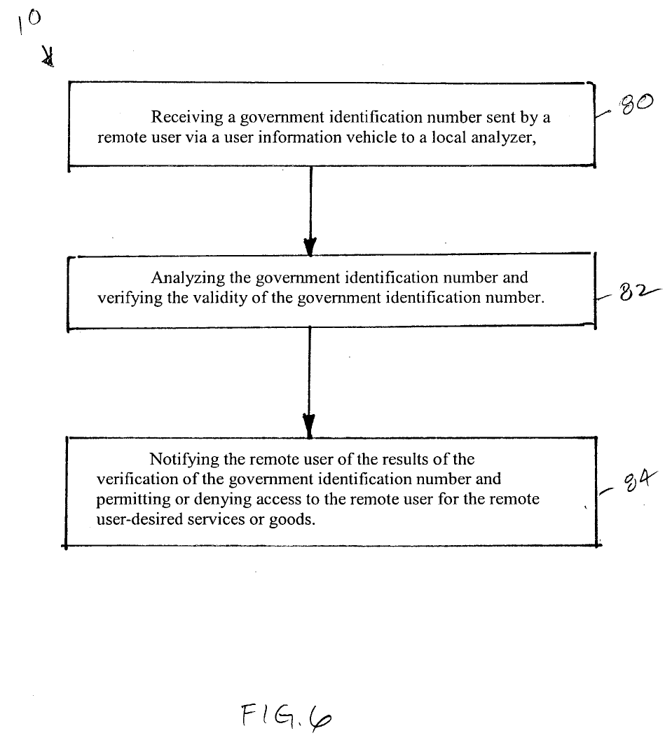

Regardless of the specific system used, as seen in FIG. 6, the system 10 receives a GID number from a remote user 12 as at step 80, analyzes the GID number as at step 82, and notifies the appropriate establishment as at step 84. Additionally, although the user 12 is described as being “remote,” the above-illustrated systems can also be adapted for non-remote, or local users.

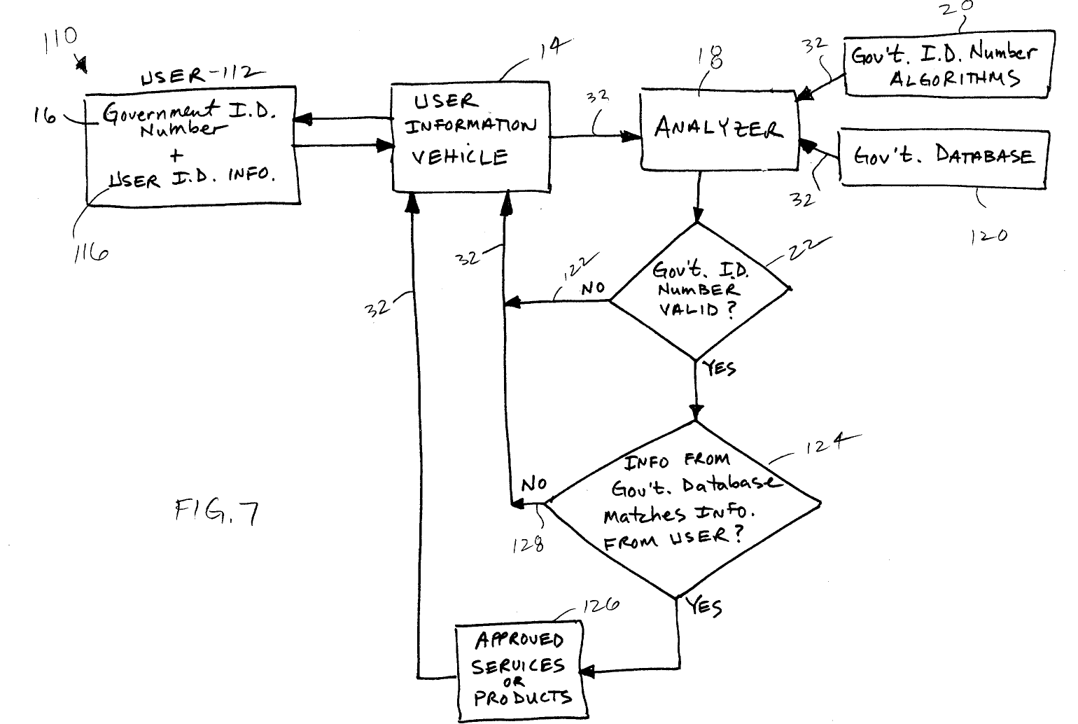

The verification of the GID number 16 as set forth above can also be used in combination with a checking of additional information supplied by a user so that analyzer 18 can not only verify the GID number 16, but also verify the accuracy of the additional information supplied by the user 112, which can help identity the person providing the GID number. FIG. 7 illustrates a system 110 in which such a second check by the analyzer 18 occurs.

In FIG. 7, a user 112, whether remote or local, provides a GID number 16 via a user information vehicle 14 to analyzer 18. System 110 is substantially identical to system 10 of FIG. 1 except that the user 112, along with the GID number 16, also provides additional user information 116. That additional information 116 can be any desired identifying information that can be used to further identify the user 116 by checking the additional information 116 against confirming-information received from a database having such identifying information, such as a government database 120. The confirming-information may be retrieved from a single database 120 or multiple databases 120. Also, the additional information 116 may include information to verify the accuracy of the information extracted from the supplied GID number 16. The additional information 116 may include personal information of the user 112 that is not included on the user's GID number 16. For example, if the GID number 16 does not provide the user's date of birth or place of birth, this information can be required of the user 112 for submitting along with the GID number 16. Thus, the additional information 116 can fill in the information gaps left by the GID number 16. Analyzer 18 will then use another source 120 to confirm the accuracy of the additional information 116, such as its own database, or a third party's commercial database, or a government database.

The specific government database 120 searched will depend upon the jurisdiction that has the relevant information. As users may have driver's licenses issued from one state and be registered to vote in another state, both the license-issuing state and the voting state may have separate databases that may be checked. Again, the level and degree of checking the additional information 116 may depend upon the level of verification that is required by the entity providing the goods and services. For example, an entity selling cigarettes may require verification of the date of birth of the user 112 and the place of birth of the user 112 if the user's age is a few years from the legal age for buying cigarettes, but the entity may simply require verification of the date of birth of the user 112 if the age of the user is many years older than the legal age for buying cigarettes. The entity can select the level of verification desired.

The manner in which analyzer 18 connects with government database(s) 120 will vary depending on the database(s) to be contacted. Since information may be required of any state or nation, analyzer may have connection capability with government databases 120 all over a country and all over the world. The access to each database may depend on the protocol of the respective state or country. For example, some government databases may be accessed by a dial-up service, while other may require the use of a frame-relay to connect to their data. Additionally, some jurisdictions may not permit direct access to their databases 120 by analyzer 18 and, instead, may require that analyzer 18 access databases 120 through, for instance, a government data center that receives the request from the analyzer 18, then processes the request by accessing the various government databases under the coverage of the data center, then providing the requested data to the analyzer 18. Of course, Internet connections make all of the various connections between the analyzer 18 and the databases 120 and/or data centers possible for instant checking of the GID number 16 and the additional information 116.

System 110 analyzes the GID number 16 in a manner substantially identical to that described above. Again, if the GID number 16 is not verified as being valid or is not verified as belonging to the user 112, a rejection is forwarded to the supplier of the goods and services 126 and to the user 112. However, if the GID number 16 is verified 22, in system 110, further analysis occurs. That is, the analyzer accesses database 120 having information that would prove the accuracy of the additional user information 116. Typically, the database will be a government database 120. For example, if the additional information 116 was the date of birth of the user 112, the analyzer would access one or multiple government databases 120 that have this information. These databases 120 may include such government databases as department of motor vehicle databases and voter registration databases. If the database 120 is remote from the analyzer 18, accessing the database 120 can be accomplished through an Internet 32 connection between the servers of the analyzer 18 and the database 120. The access of the algorithm database 20 can similarly be achieved through an Internet 32 connection.

The additional information 116 can also be an electronic signature, including as described herein, created by the user 112 on his computer and sent to the analyzer 18 for comparison to an electronic signature of the user 112 that is stored in a database of analyzer 18 and that had been previously authenticated. The additional information 116 can also biometric information, including keyboard stroke biometric information as described herein, which is compared by the analyzer 18 against previous authenticated biometric information accessible by analyzer 18.

The analyzer 18 performs an analysis 124 of the additional information 116 and the information retrieved from the database 120 and if the additional information is determined to be accurate, access to the goods and services requested by the user 112 is approved. Otherwise, access is rejected 128.

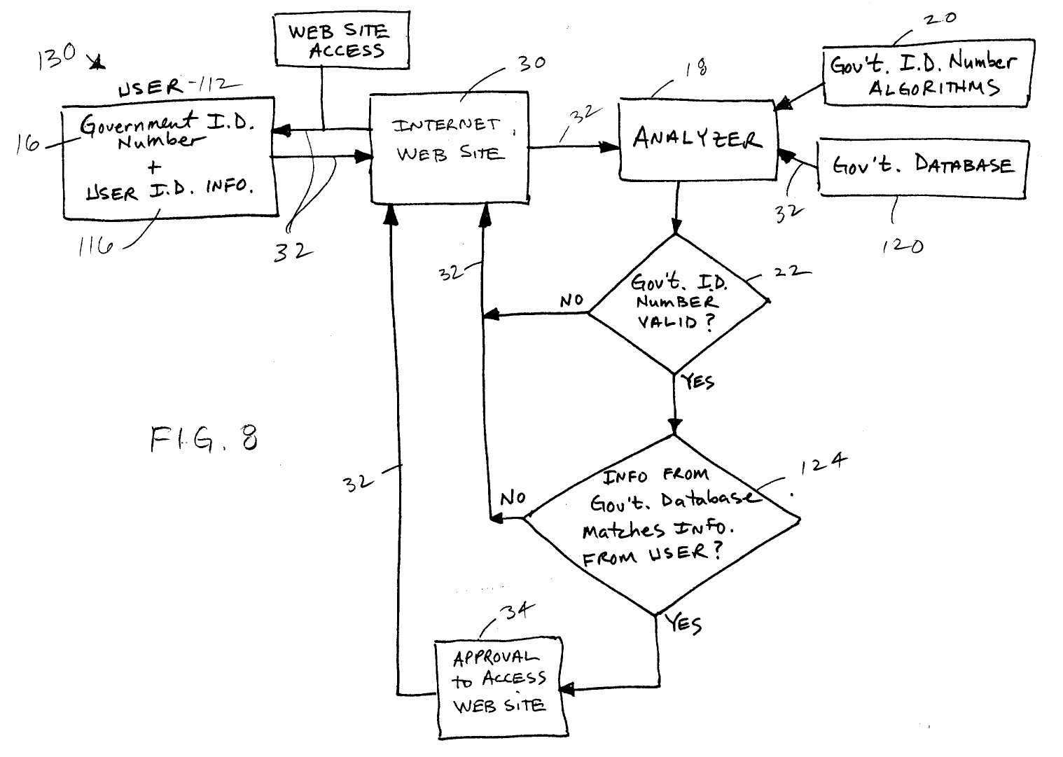

An embodiment of the system 110 is illustrated in FIG. 8 as system 130. System 130 is substantially identical to system 110 except that in FIG. 8, the user 112 desires access to Internet Web site 30. Also, system 130 is substantially identical to system 28 illustrated in FIG. 2, except system 130 requires the user 112 to supply the additional user information 116. Access to the Web site 30 is then dependent upon not only the verification of the GID number 16, but also on the accuracy of the additional user-supplied information 116. As mentioned above, the method of user providing additional information 116 to the Web site 30 and to the analyzer 18 can be the same as providing the GID number 16. Additionally, the additional information 116 can be provided along with the GID number 16.

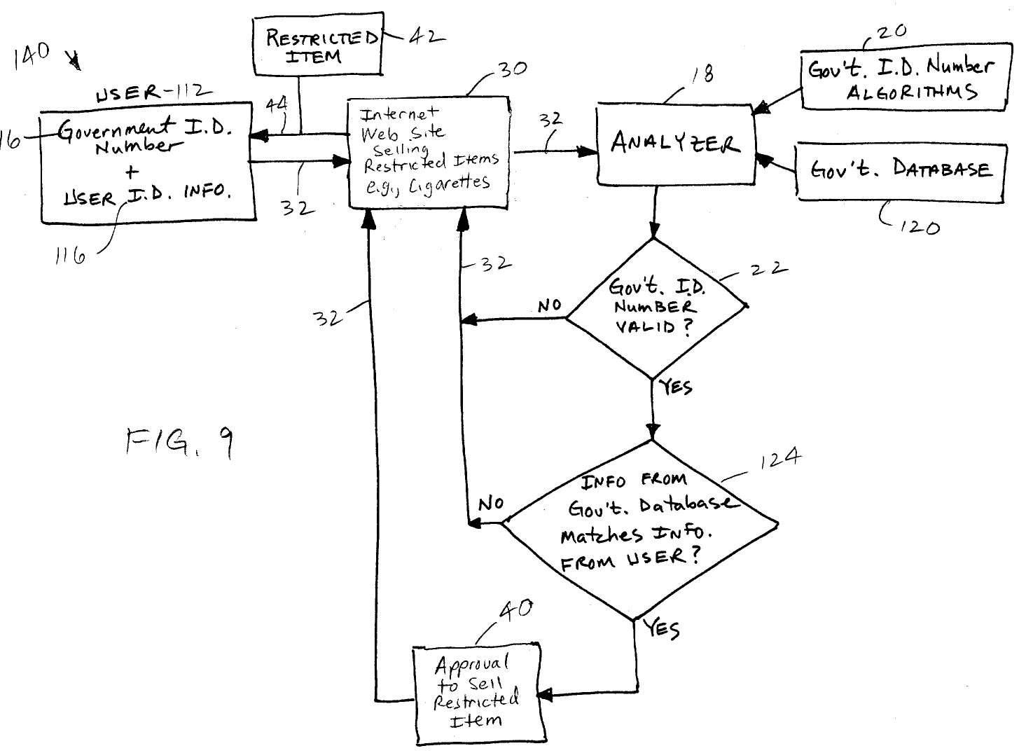

FIG. 9 illustrates a system 140 that is substantially identical to system 130 except instead of obtaining access to an Internet Web site 30, the user 112 desires to purchase government-restricted items 42 via an Internet Web site 30. System 140 is also substantially identical to system 38 illustrated in FIG. 3 except system 140 requires the user 112 to supply the additional user information 116. Access to the restricted items 42 is then dependent upon not only the verification of the GID number 16, but also on the accuracy of the additional user-supplied information 116.

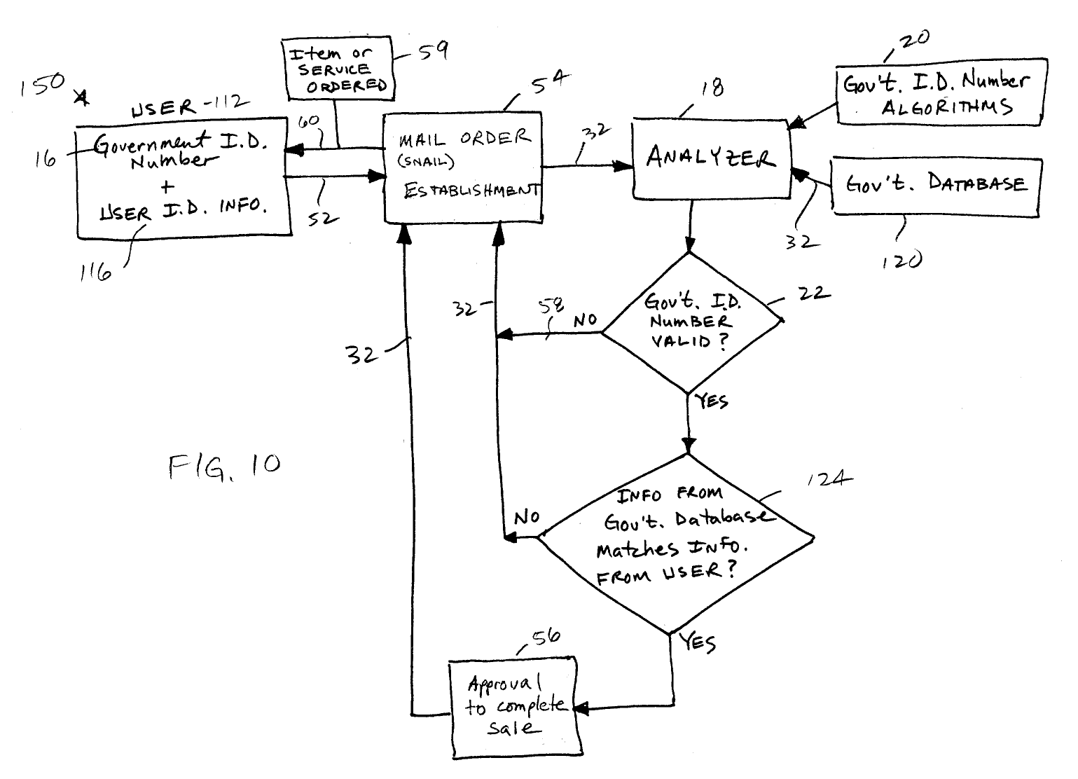

FIG. 10 illustrates a system 150 that is substantially identical to system 130 except instead of obtaining access to an Internet Web site 30, the user 112 desires to purchase items or services 59 via a regular postal mail delivery system 52 from a mail order establishment 54. For example, the user 112 may desire to purchase government-restricted items such as cigarettes. System 150 is also substantially identical to system 50 illustrated in FIG. 4 except system 150 requires the user 112 to supply the additional user information 116. Access to the desired goods and services 59 is then dependent upon not only the verification of the GID number 16, but also on the accuracy of the additional user-supplied information 116.

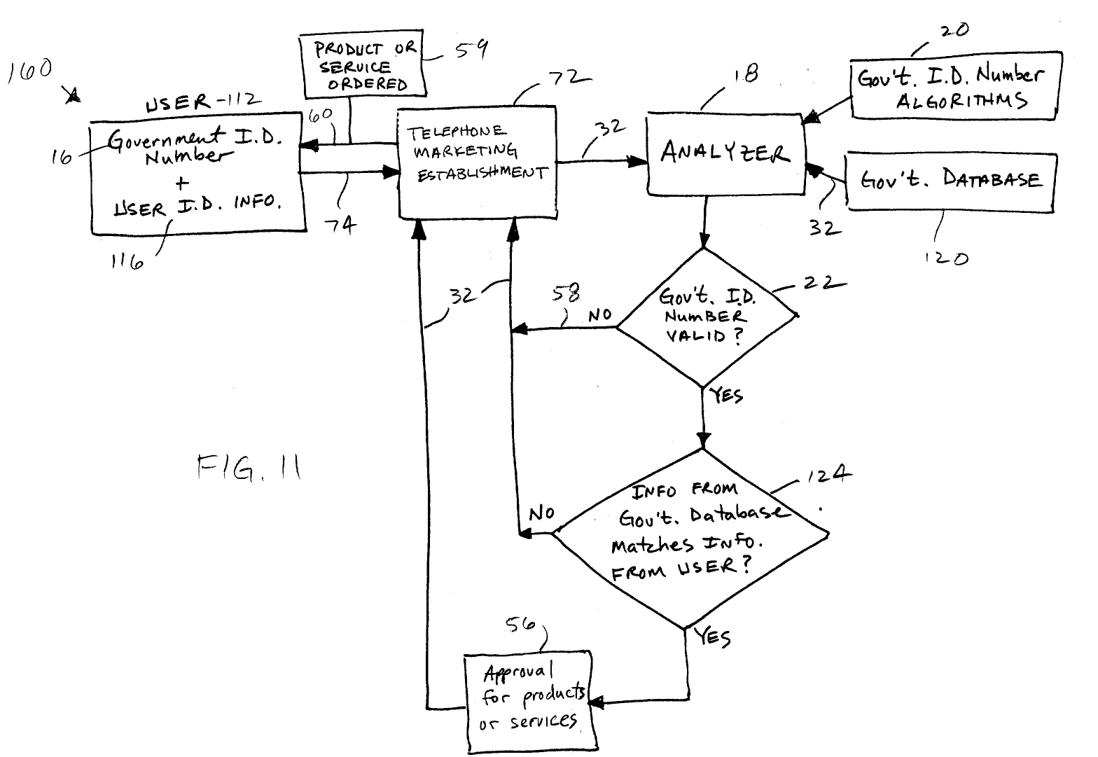

FIG. 11 illustrates a system 160 that is substantially identical to system 150 except instead of obtaining goods and services through regular postal mail, the user 112 desires to purchase items or services 59 via a telephone delivery system 74 from a telephone marketing establishment 72. For example, the user 112 may desire to purchase government-restricted items such as cigarettes. System 160 is also substantially identical to system 70 illustrated in FIG. 5 except system 160 requires the user 112 to supply the additional user information 116. Access to the desired goods and services 59 is then dependent upon not only the verification of the GID number 16, but also on the accuracy of the additional user-supplied information 116.

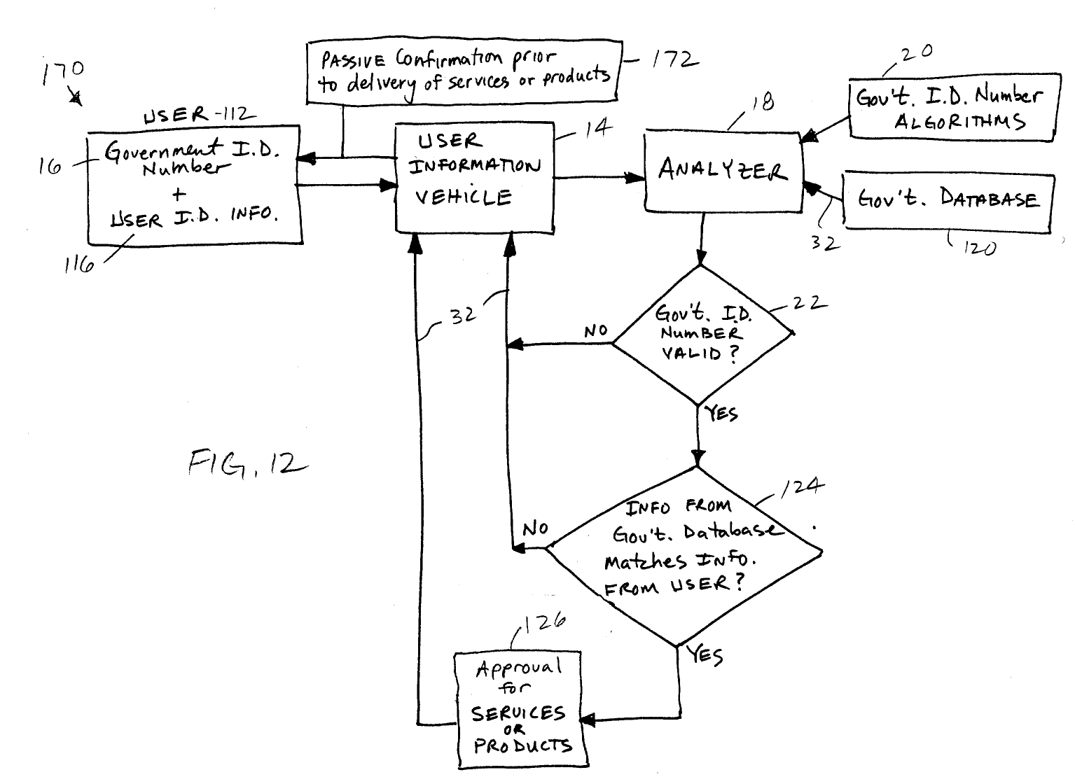

FIG. 12 illustrates a system 170 that is substantially identical to system 110 illustrated in FIG. 7 except that it includes sending a confirmation 172 to the user 112 that the desired access to the goods and services is, in fact, desired and that a request for the goods and services has been made. The confirmation 172 can be a notification to the user 112 that someone representing themselves as the user 112 has requested the desired goods and services 126. The confirmation 172 can be a passive confirmation in which no response is necessary unless the user 112 discovers through the confirmation 172 that the actual user 112 did in, in fact, request the access indicated. Then, the user 112 can contact the supplier of the goods and services to cancel the request. The confirmation 172 can be sent via the Internet 32 in the form of, for example, an electronic mail (e-mail) or an electronic signature of the user 112 obtained during the request for the goods and services. The confirmation 172 can also be sent by other mechanisms, such as a regular postal mail delivery. The confirmation 172 can also be in the form of a telephone call to the user 112, such as an automated telephone call to the user 112 alerting the user 112 that a request has been made for the goods or services and providing information as to how the user 112 can contact the supplier of the goods and services 126 to cancel the order.

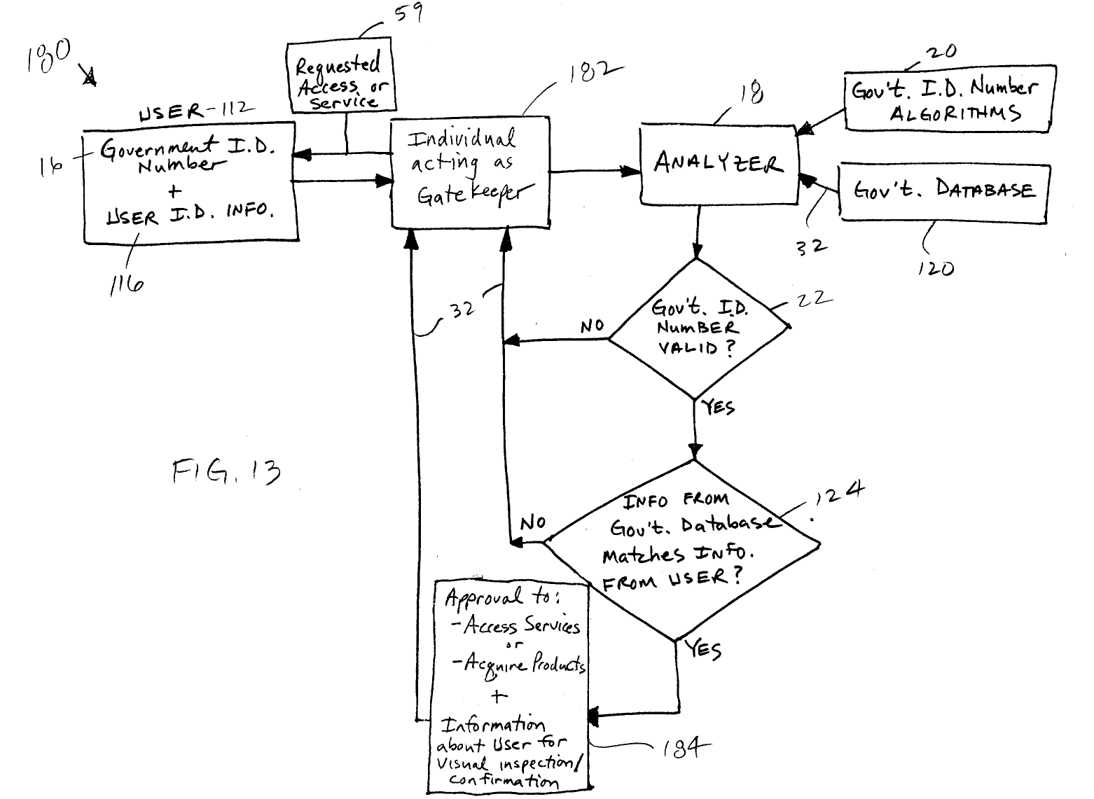

FIG. 13 illustrates another system wherein the user 112 desires to access goods and services and wherein the user 112 is physically located at the site of the goods and services, (as opposed to being “remote” from the goods and services as mentioned above). Specific examples of system 112 include user 112 requesting permission to pass an airport security screening checkpoint and user 112 requesting to buy government-restricted goods, such as cigarettes, from, for example, a convenience store. System 180 is substantially identical to system 110 except for the delivery of the information 16 and 116 by the user 12, and the possible visual inspection that can occur in addition to the verification of the GID number 16 and the additional information 116.

In system 180, the user 112 presents himself or herself to an individual acting as a gatekeeper 182, such as a store clerk or an airport security screener. The user 112 provides the GID number 16 by appropriate mechanism including a scanning of the government identification card on which the number exists into a computer or by typing directly into a computer or by providing the number to the screener who in turn enters the number into a computer, etc. The user 112 is also prompted either by computer or by the gatekeeper 182 to provide additional information 116. The additional information 116 can be, for example, directly inputted by the user 112 into a computer or provided to the gatekeeper 182 for inputting into a computer. The information 16, 116 is then passed to the analyzer 18 as described above. The entry of the GID number 16 and the additional information 116 can be made directly into the analyzer server 18 if the server is local to the gatekeeper's computer. If the analyzer server 18 is not local, the information 16 and 116 can be provided via the Internet 32 as set forth above.

For example, if a user 112 approaches a convenience store clerk 182, the clerk 182 can “swipe” the user's GID card containing the GID number 16 across a card reader or magnetic strip reader connected to a computer located in the store, or the clerk 182 can enter the information 16 and 116 into the store's computer by other mechanisms, including typing. Then, through a modem, the information can be sent to the analyzer 18 via the Internet. Also, the clerk 182 could access an Internet Web site that is connected to analyzer 18 and the information could be entered into the Web site. The Web site would then forward the information to the analyzer 18. The information 16 and 116 is captured in the computer server of the analyzer 18. The clerk 182 can receive a unique transaction ID and may get a match code depending on the predetermined manner in which the convenience store is integrated to the analyzer 18. For example, the convenience store may have a prearranged system configured with manager of the analyzer 18 such that if the GID number 16 is valid and the information 16 and 116 confirms a birth date, a single code may be transmitted to the clerk 182, such as “OK.” However, if a lesser degree of verification is requested by the store, the clerk 182 may receive an approval if only the GID number 16 is determined to be valid. Various levels of authorization and verification can be predetermined by an entity employing the analyzer 18 systems. Levels of authorization and various forms of additional information 116 that can be individually or cumulatively added for various levels of authorization as disclosed below and include, among other possibilities, electronic signatures and keyboard biometric information. The GID number 16 and the additional information 116 is then analyzed as discussed above with respect to the other embodiments and approval or rejection of the user 112 is determined and the gatekeeper 182 is notified, for example, by a return message from the analyzer 18 to the gatekeeper's computer. Thus, the gatekeeper will then permit access to the goods and services as dictated by the determination of the analyzer 18.

Additionally, since the user 112 is physically in the presence of the gatekeeper 182 in system 180, additional visual inspection can also be obtained by the gatekeeper 182 upon the gatekeeper being provided with identifying information provided by the analyzer 18 that was extracted from the GID number 16 and/or from the databases 120 containing information on the user 112. For example, if the GID number 16 and the additional information 116 is verified along with the approval 184 sent to the gatekeeper 182, the gatekeeper 182 is also sent information extracted from the GID number 16 and/or the database 120. The gatekeeper 182 can then read the information on the user 112 and make visual inspections and/or pose additional questions to the user to further check identity. For example, if the GID number 16 includes the user's date of birth, but the information is embedded in the GID number 16 and therefore not plainly evident, the date of birth can be extracted from the GID number 16 and forwarded to the gatekeeper 182. The gatekeeper 182 can then visually confirm if the user is the age identified in the GID number 16. Similar information about the user 12 can be extracted from various commercial and government databases for similar purposes.

The gatekeeper 182 can also be a mobile individual delivering items to the user 112 and requesting the GID number 16 and/or the additional information 116 and processing the information received from the user 112 via, for example, a mobile, handheld wireless electronic device that supplies the information 16 and/or 116 via a wireless phone connection or wireless Internet connection to the analyzer 18 either directly or through an Internet Web site. After the information 16, 116 is analyzed by analyzer 18, a wireless communication from the analyzer 18 to the mobile gatekeeper 182 could permit the gatekeeper to deliver the item. One example of this application would be an express package mail delivery system.

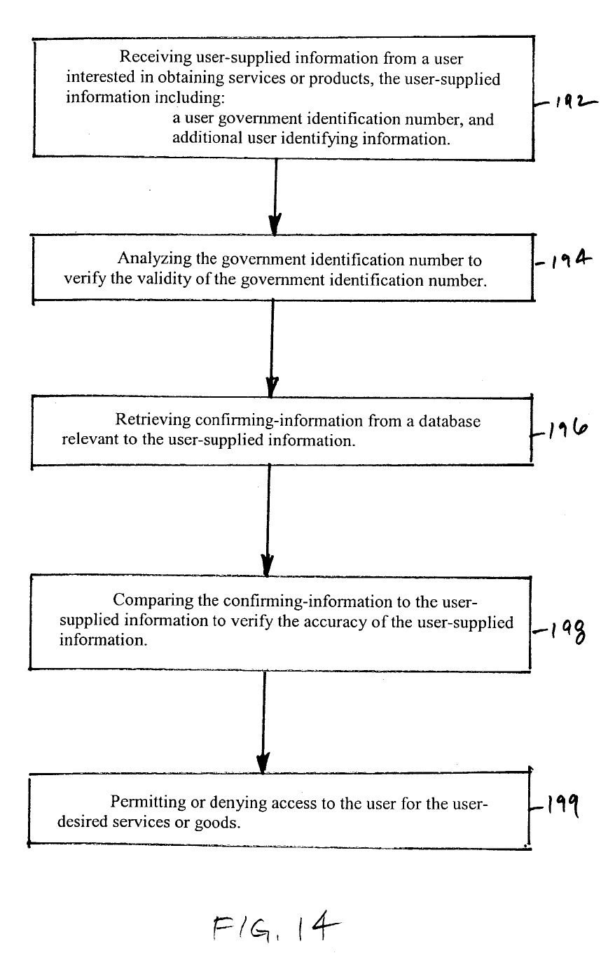

FIG. 14 illustrates the general methodology of one of the embodiments of the invention, including receiving 192 the user information 16 and 116, verifying 194 the GID number 16, retrieving 196 confirming information from a government database, determining 198 the accuracy of the additional information 116 and permitting or denying 199 access to the desired goods and services.

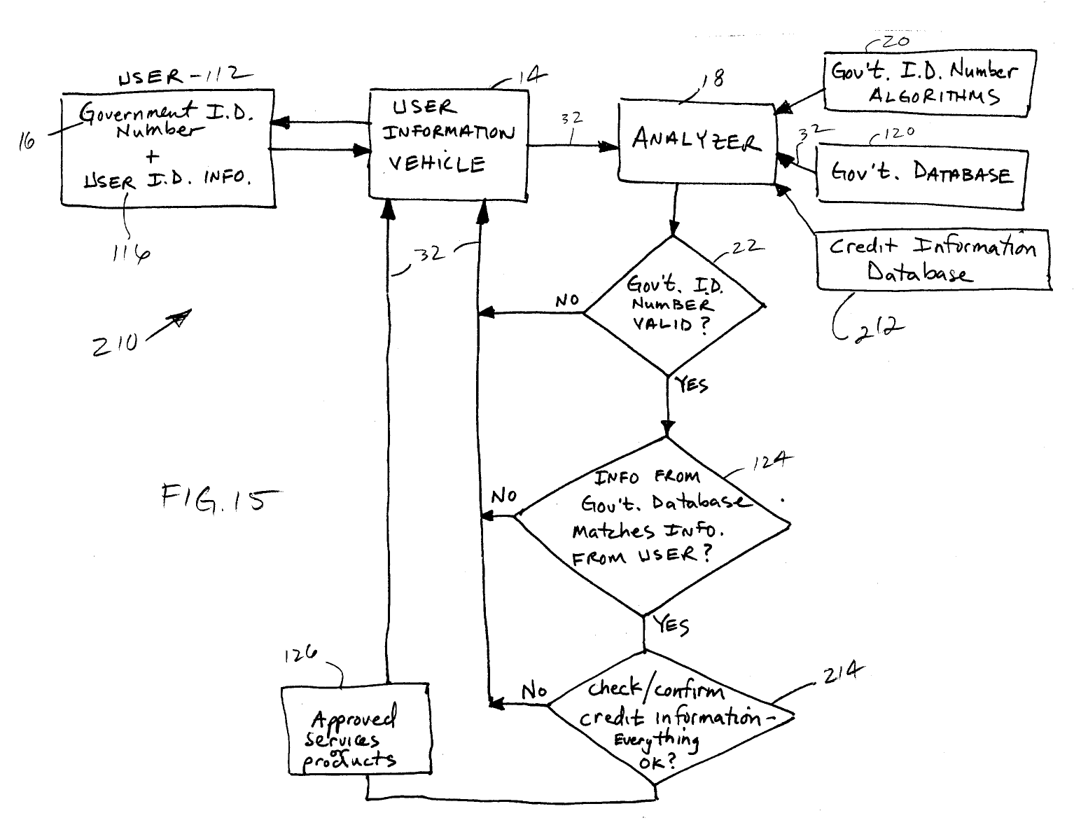

FIG. 15 illustrates a system 210 that is substantially identical to system 110 of FIG. 7, except that the system 210 further includes a financial credit check of the user 112. As seen in FIG. 15, analyzer 18 can retrieve financial credit information on the user 112 from a financial credit information database 212. Then, the analyzer 18 can check 214 the financial credit of the user prior to approving the user 112 for access to the desired goods and services 126. This is particularly useful when the user must provide a large sum of payment for receiving the goods and services 126. The user's 112 financial payment and account information can be provided by the user 112 along with the GID number 16 and the additional information 116 and at the time of requesting the goods and services.

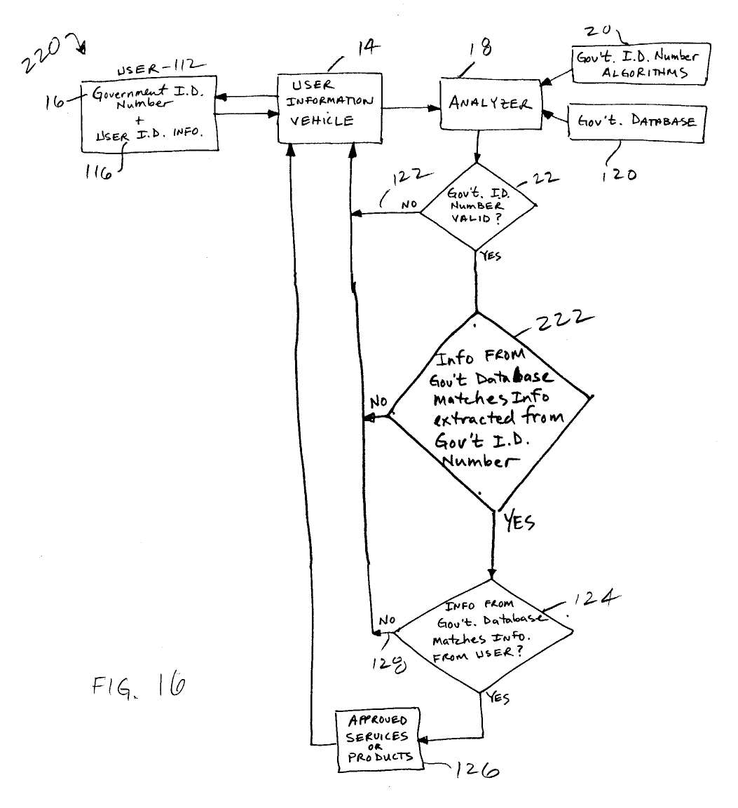

FIG. 16 illustrates a system 220 that is substantially identical to system 110 except that system 220 includes the additional checking 222 of the GID number 16 against the information retrieved by analyzer 18 from the government database 120. For example, if the date of birth has been extracted from the GID number 16 and a government database 120 has the user's 112 date of birth, the date of birth information from the GID number 16 and the date of birth retrieved from the government database 120 can be compared. Thus, system 220 not only analyzes the GID number 16 for conformance with the formal parameters of the GID number of its jurisdiction, but also confirms the accuracy of the information extracted from the GID number 16.

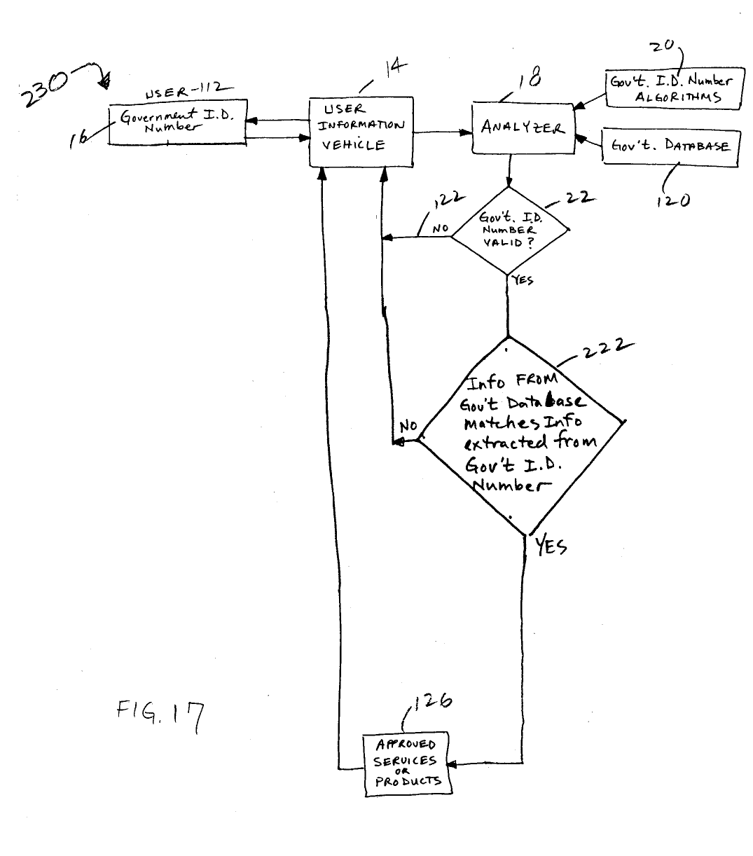

FIG. 17 illustrates a system 230 that is substantially identical to system 220 except that system 230 does not necessarily retrieve the additional information 116 from the user 112 and, therefore, does not necessarily check the additional information 116. Instead system 230 merely checks the GID number 16 for format as set forth above such as in system 10 in FIG. 1, but then additionally checks the accuracy of the GID number 16 against information retrieved by analyzer 18 from the government database(s) 120. Thus, system 230 not only analyzes the GID number 16 for conformance with the formal parameters of the GID number 16 as set by its respective jurisdiction, but also confirms the accuracy of the information extracted from the GID number 16.

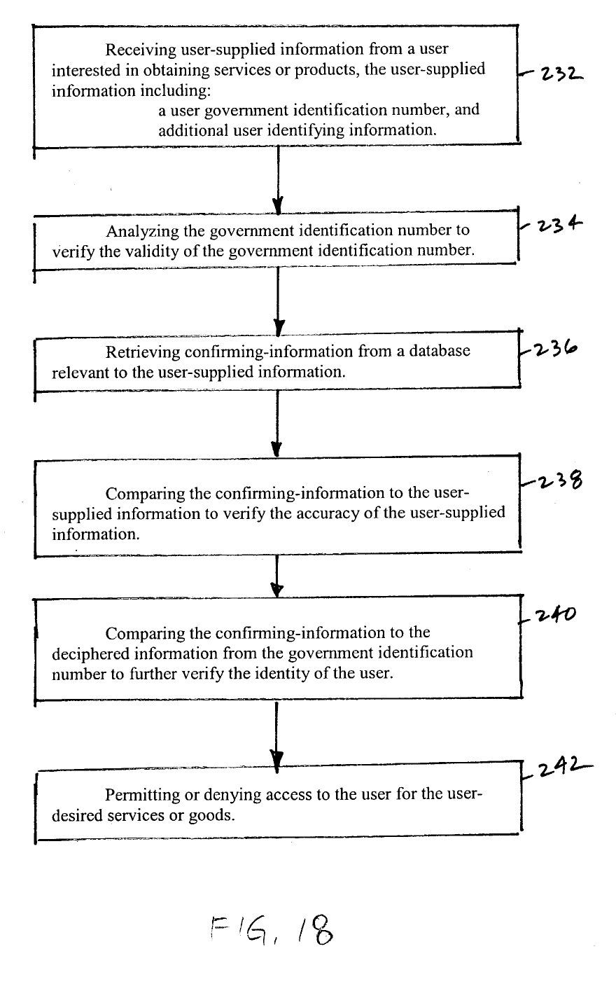

FIG. 18 illustrates the method of FIG. 16 as receiving 232 the GID number 16, analyzing 234 the GID number 16 for information, retrieving 236 information from the government database 120, determining 238 the accuracy of the user-supplied information 116, determining 240 the accuracy of the information extracted from the GID number 16, and permitting or denying 242 access to the user 112 of the goods and services.

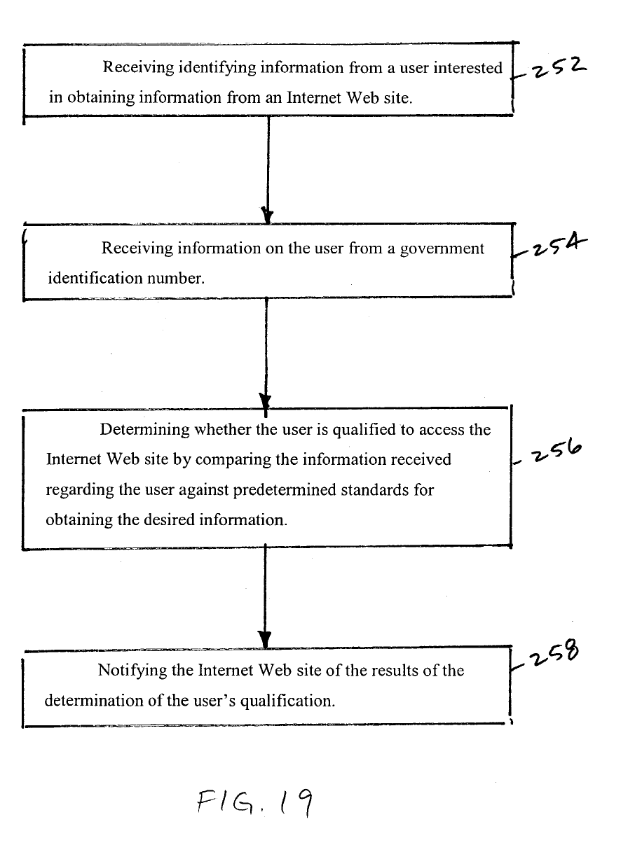

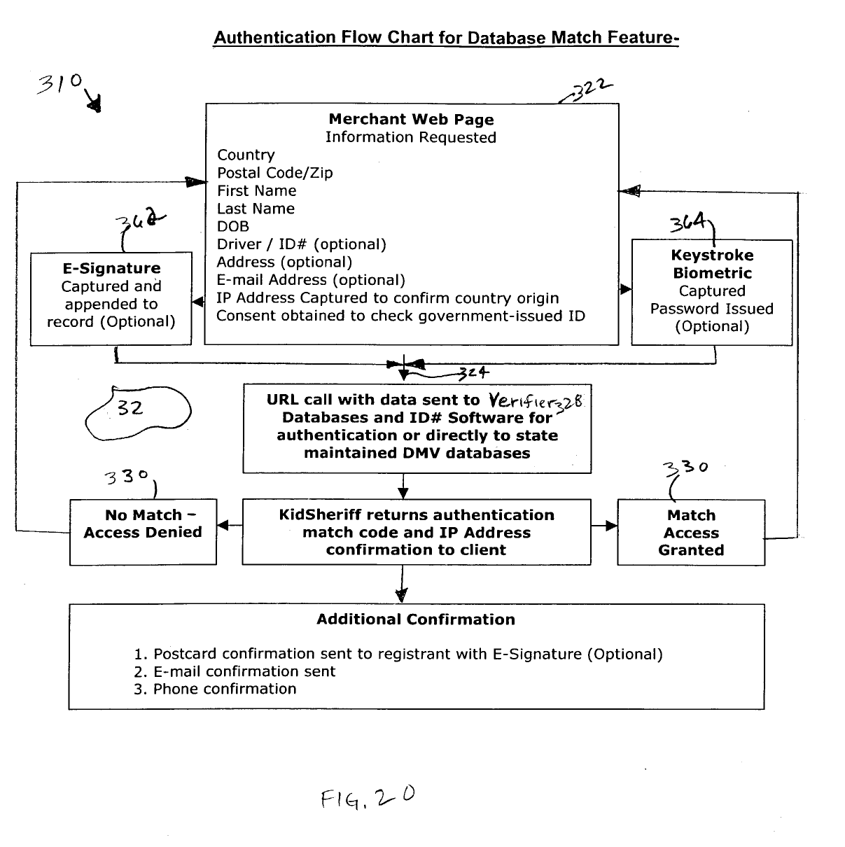

FIG. 19 illustrates another embodiment of the invention in which the information is received 252 from the user, information is extracted 254 from the GID number, a determination 256 is made as to whether the user has satisfied predetermined standards, and the user is notified 258 of the results of the determination to access the goods and services. For example, the gatekeeper of a Web site may desire to only grant access to those whose age can be confirmed even though the user's place of birth can not be confirmed.

It should be understood that the methods and apparatus disclosed herein are intended for use both in stopping fraudulent activities associated with identification fraud but also for use in reduce friendly fraud to, for example, deter subsequent repudiation of credit card charges or other activities.

FIG. 26 illustrates a sample URL format for sending user information to the analyzer 18.

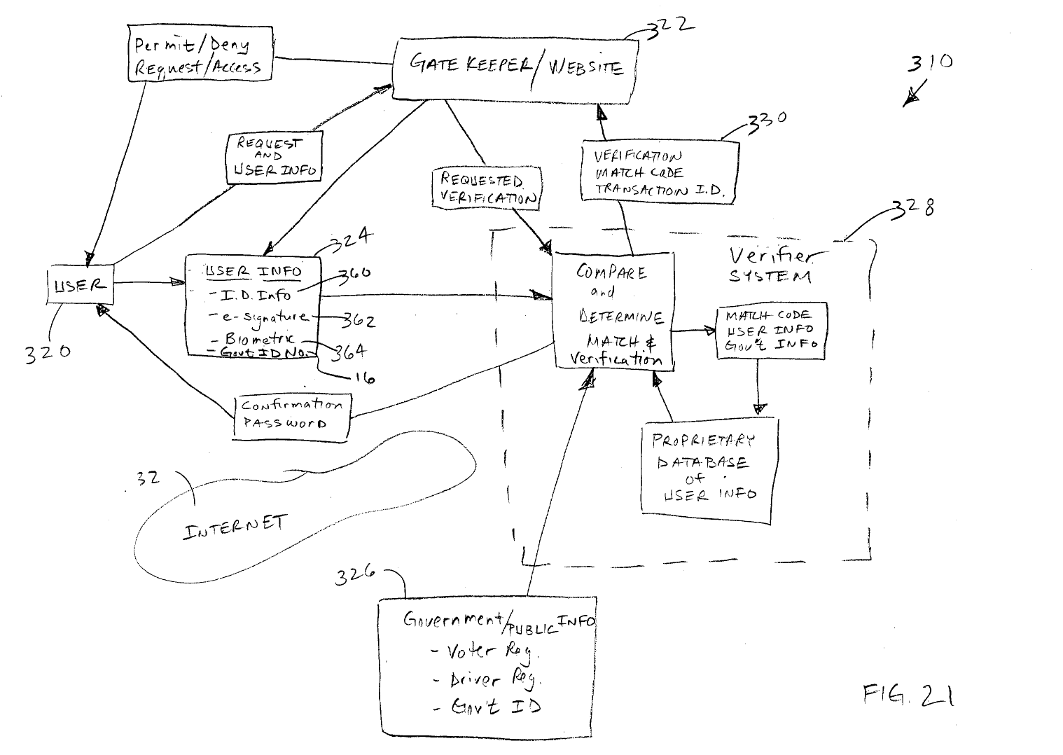

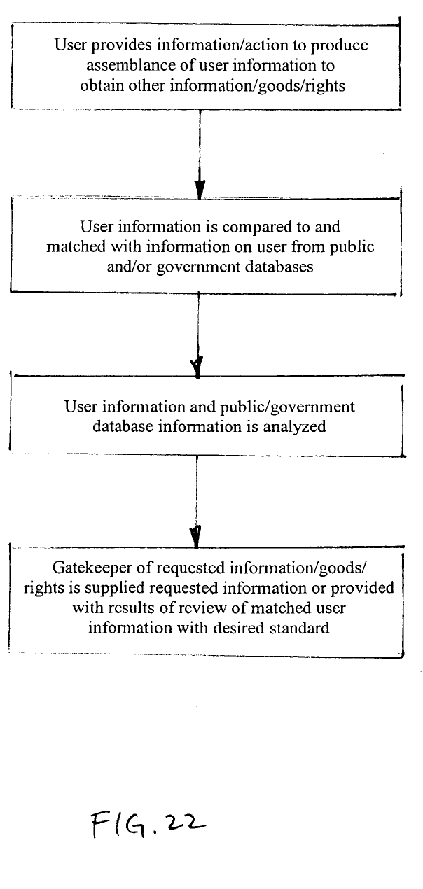

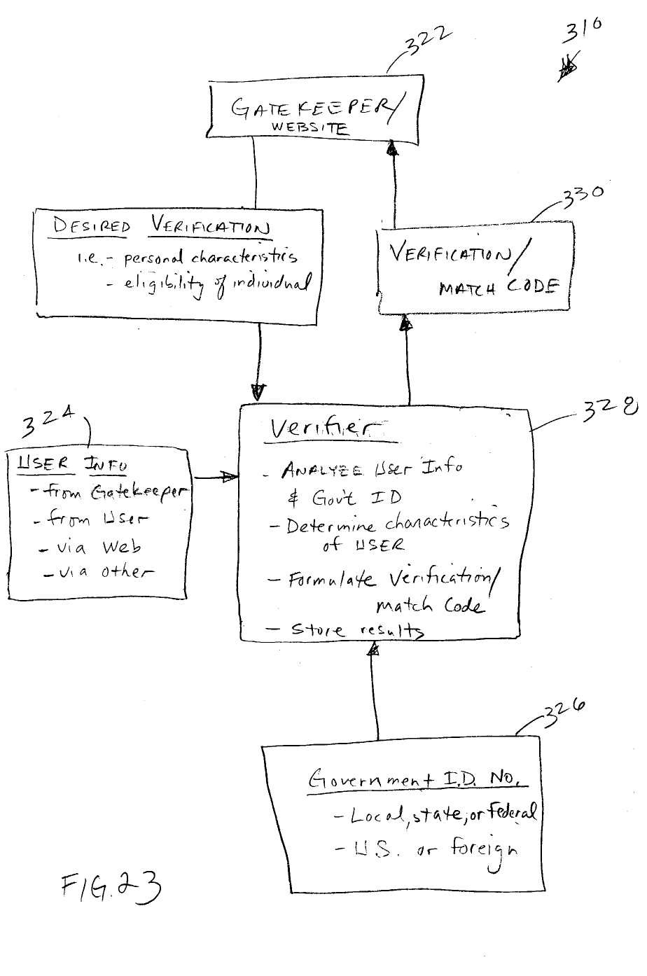

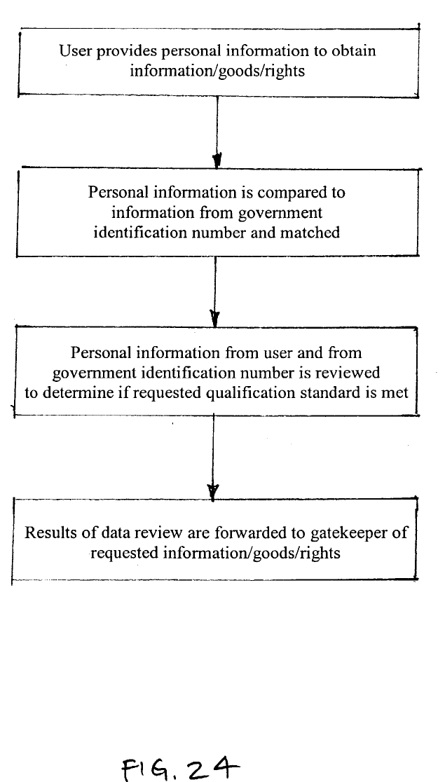

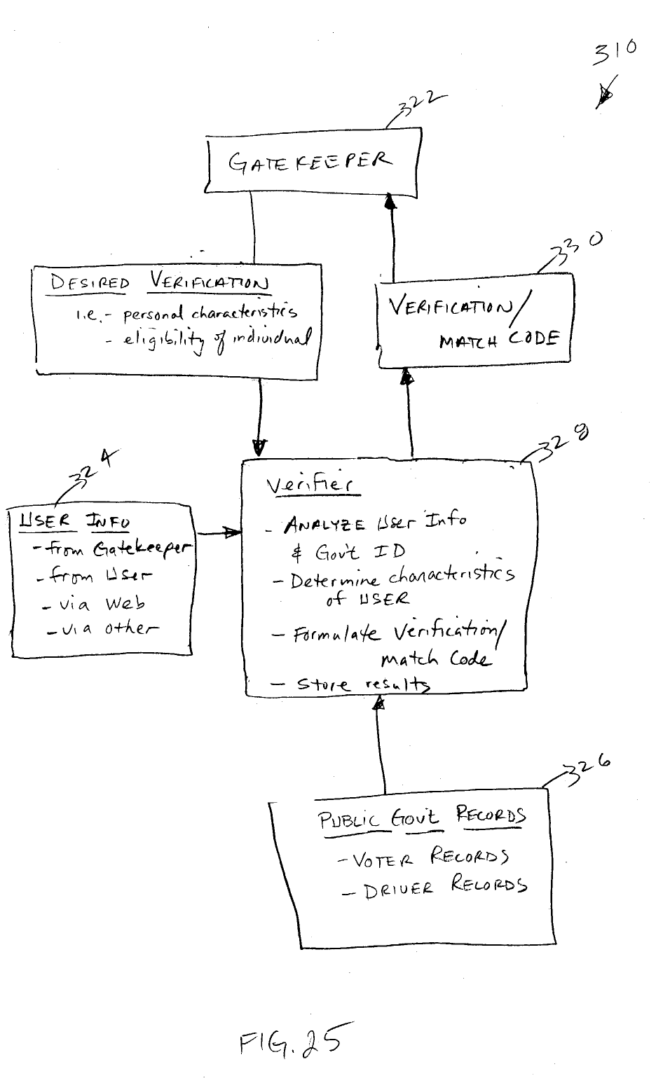

As seen in FIGS. 21-25, another illustrated embodiment of the invention provides a system for “carding,” or checking the identification of individuals prior to their obtaining desired information, goods, or rights. More specifically, an illustrated embodiment of the invention provides a system for checking the identification of individuals 320 who wish to access an Internet Web site 322. The Web site 322 requires the individual or user 320 to supply certain information 324. That information 324 may be in the form of personal identification information 360, signature information such as an electronic signature 362, and/or biometric information such as information relating to the user's key stroke time sequence 364. User information is also obtained independent from the user 230 by accessing public record and/government databases 326 such as motor vehicle driver information and voting registration information. User information may also be obtained by accessing government identification numbers 16 and analyzing the information therein as set forth above. Then, all the obtained user information is compiled and a determination is made whether the user 320 qualifies for obtaining the desired information, goods, or rights. The qualification could be predetermined commensurate with nature of the information, goods, or rights. The information 324 acquired from the user 310 and from the databases 326 can then be saved for an even more efficient verification process in the future.

An illustrated embodiment provides an age and/or identity authentication system 310 incorporating a database match, a physical electronic “signature” 362, a biometric keystroke analysis 364, and an algorithm to verify identity, age or nationality of individual based upon an identification number 16 issued by a government agency

In particular, in the verification system 310, a Web site 322 can send Web site user information 324 collected at the Web site 322 for verification of, for example, instantaneous age or identity authentication. The verifying server and its network or verifier 328 of the invention instantly confirms the user information 324 against public record data of U.S. and international citizens from government or public databases 326 and issues the Web site 322 a match code 30 confirming the identity and age of the Web site user 320.

To accomplish this substantially instantaneous data match, the Web site 322 provides the verifier 328 with the Web site user information 324 via the Internet 32 using standard hypertext transfer protocol and a URL (uniform resource locator) call with a data string for instantaneous matches. The verifier 328 is designed to allow the Web site 322 to handle the data entry and receipt pages. Therefore, the verifier 328 will accept a URL with criteria information and return a simple authentication match code 330. The verifier 328 uses a series of authentication match codes 330 based on predetermined criteria to establish a match between the Web site user information 324 and the data accumulated by the verifier 328 from the databases such as the government databases 326. Where there is a match, the verifier 328 will record the match and return the match code 330 and transaction ID (identification) to the Web site 322 or Web site manager.

The system 310 can use a Web page of a Web site 322 that collects user information (e.g., name, address, date of birth). When the user 320 submits the information 324, the Web site 322 server code constructs the URL string and sends it to verifier 328 for processing. The method for calling the URL within a server-side script will vary, depending on the language used by the Web site 322 program. Nothing need be installed on the Web site 322 or user's server. The Web site 322 application code makes a call to Verifier 328 using the syntax provided. How the call is made can depend entirely on the Web site 322 server. Therefore, there are no OS (operating system) requirements other than programming the call to verifier 328. Then, the results or match code 30 is sent back to the Web site 322. The Web site 322 parses the string to obtain the match code (MC) 30. The Web site 322 application can then direct the user 320 to the appropriate Web page on the Web site 322 depending on the results. Verifier 328 may only be involved in the actually determining the results of the verification and sending them back to the Web site 322. The URL call goes into the Web site 322 code, as though the Web site 322 was selecting data from its local database. But instead of requesting data from the Web site 322 database, it is simply requested from Verifier 328 using the Direct URL string. Then a response from verifier 328 is produced. An example of a URL format is illustrated in FIG. 26.

Alternatively, if a merchant or gatekeeper of the information, goods, or rights desired by the user 320 does not have a Web site 322, the system 310 can be adapted to provide a Web interface (internal or external) to help the merchant or gatekeeper of the desired information, goods, or rights collect and maintain Web site 322 user information 324. The system 310 can be adapted to provide an active server Web site 322 Web page with customizable fields to collect Web site 322 user information 324 and consent for instantaneous matches.

Further, a merchant or gatekeeper of the information, goods, or rights, including a Web site 322 manager, can provide information off-line, that is, not using computers or the Internet, and simply deliver user information 324 that can then be entered into verifier 328 and match codes 330 provided either by Internet connection or simply hard copies and other information not using the Internet or computers for delivery. The off-line information can be user 320 information for an individual user 320 or an entire database of information that is related to multiple potential users 320.

Web site 322 user information 324 can be collected and supplied to the verifier 328 server. When there is a match between the user information 324 from the Web site 322 user 320 and the data obtained by verifier 328, verifier 328 can record the match and direct the user 320 to a Web page location on Web site 322 specified by the Web site 322 based upon a predetermined set of match codes 330. The Web site 322 may access and download matched data through a Web site administered by the verifier 328. For example, an internal Web screen for Web site 322 managers and staff can be provided if they are authenticating users 320 over the phone using system 310.

If the system 310 is verifying based on government databases 326, the system 310 requires the user 320 to provide certain personal information 324 that is contained in public voter and driver record databases. If the personal information 324 provided by the user 320 matches the information in the public record database 326, the system 310 provides the Web site 322 owner with a match code 330 or confidence code stating the level of certainty of the match.

With respect to accessing public databases 326, the authentication system 310 obviously can be used for any type of data. In one situation, a cross-matched data layer built upon both public records and vendor data will often be necessary for obtaining acceptable authentication results.

Although voter and motor vehicle registration information are mentioned as possible data bases 326 to access, the system 310 can access a variety of databases and information. For example, the system 310 can be modified to accommodate authenticating on hybrid data sources, especially in the case when merchant data is available. Two basic models in this case are offline matching and online real time cross-matching.

The system 310 can also verify information based on information it receives from a government identification number 16 and act separately or in conjunction with the systems described above utilizing analyzer 18. In this case, system 310 incorporates an algorithm so that it can verify such things as identity, age, or nationality of the user 320 based upon an identification number 16 issued by a government agency, as set forth above. The government identification number 16 can be supplied by local, state, or federal governments and by the United States or foreign governments. The analysis will be dependent on the contents of the identification number 16. For example, the verifier 328 can analyze the length and contents of the identification number 16 issued by the governmental agency to ascertain such things as the user's 320 identity, age, nationality, place of birth, relatives, length or residence, other identifying personal characteristics or eligibility under governmental or commercial regulations to operate a motor vehicle, possess a firearm, transit national borders or acquire products or services intended for adults. Thus, the verifier 328 would obtain the government identification number 16 and then interpret its contents to obtain the information therein regarding the user 310 to whom the identification number relates. Also, depending on the characteristics of the identification number 16, the verifier 328 can obtain the government identification number 16 either from the government or the user 310 and use it as a password to access the appropriate information regarding the user 310 stored in a database wherein the data on the user is stored by the government identification number 16.

The user supplied information 324 can simply be identifying data 360 provided by the user 320. Additionally, the user supplied information 324 may include additional user information such as signature information and physical information or a GID number 16. For example, the user 320 can be required to create user information 324 that includes things such as an electronic signature 362 and/or a biometric analysis. One example of a biometric analysis can be a key board stroke analysis 364.

In the case of requiring an electronic signature, various methods of obtaining electronic signatures may be utilized. For example, some of the patents cited above and incorporated by reference herein include methods of acquiring electronic signatures and those methods can be adapted for use with system 310. Preferably, however, the electronic signature is as described and illustrated in the subject application.

The preferred electronic signature or e-signature 362 process involves a computer-based apparatus and method that permits for the authentication of the Internet user 320 through the user 320 or Web site 322 creation of user input images in the form of a e-signature based on Java Applet. In one embodiment, the e-signature is created by the user 320 holding down a button on a computer mouse, such as on the user's personal computer, and forming the e-signature 362 with by moving the mouse. These images are transferred instantaneously to a Java Servlet in verifier 328 to be processed as Java image objects 362. This e-signature process facilitates the creation of user-inputted electronic signatures on Web site 322 Web pages wherein the Java Servlet in verifier 328 interfaces with universally supported Java Applet within user 320 or Web site 322. (Servlet is the Java program running on a server machine such as with verifier 328. Applet is the Java program running on the user 320 or Web site 322 machine.)

With respect to server architecture, the system for e-signature 362 can function with any Java Servlet-enabled Web server and Java-enabled network servers.

The system for e-signature 362 can use a “smoothening” algorithm that assists in forming a more accurate signature 362. That is, a variable number of control points are identified between each of the vertices of the segments, which reflects the fitting criteria pre-set by the system. This fitting algorithm can be based on the use of Bezier curves, wherein if a maximum error is exceeded, a redetermination of the control points is applied to reduce the error. The e-signature 362 can be captured and stored on the verifier 328 server.

For users 320 whose confidence code or match code 330 is at a level acceptable to the Web site 322 owner, the system 310 associates the e-signature 362 with the information in that record. Also, a password corresponding to the e-signature 362 may be provided to the user 320. The verifier 328 then retains the associated signature 362 and record for later reference by the Web site 322 when authentication of the user 320 is required again, either for future online transactions, or for offline signatures, such as those collected by shippers at the point of delivery. The system 10 also may evaluate the signature 362 using biometrics or other methods of determining such things as identity, authenticity, or geographic location.

The electronic signature 362 is preferably a captured signature in graphic form as illustrated in the drawings. More specifically, the e-signature 362 is an electronically captured signature in its graphic form. However, electronic signature 362 can encompass merely a long string (e.g.,. GHHSJ8973kkdffjasdfk92ks) (without being in graphic form) and still be used for security checks. Additionally, the captured graphic e-signatures 362 from user 320 can be used as a long string electronic signature as well as a graphic e-signature because the graphic e-signature 362 can be expressed in a string form.

Biometric analysis of the user may be performed for an even higher degree of investigation and confirmation of the user 320 and various methods of biometric analysis can be included with system 310. For example, biometric analysis described in some of the patents cited above and incorporated herein may be adapted and used with system 310 to supplement the user information 324. However, the preferred biometric analysis is described and illustrated in the subject application as a key stroke analysis, which can be included in the information 324 supplied by the user 320.

Preferably, user 320 types into a browser with a Client-Side script language like Javascript, VBScript or a browser supported client technology implemented with Java or ActiveX.

Forming the key stroke analysis includes a statistical training phase. The analysis requires the user 320 to provide keystroke inputs a number of times for statistical training purpose. When a user 320 fills out a form on a Web page of a Web site 322 and approves the information (e.g., clicks “Accept Entry”), the user's 310 key stroke time sequence is stored on the Web page along with the actual entry content. This may implemented using Script language such as JavaScript language. The Script program checks if a particular user input matches with a previous entry and gives corresponding warnings instantaneously. This mechanism insures entry data integrity.

After satisfying the determined number of trials, (e.g., eight trials), a user 320 completes training and submits all the keystroke time sequences 362 along with the form data to the verifier 328 of system 310 for future analysis and use.

During the analysis 364, keystroke time intervals can be calculated. For example, the time to move from the key “j” to the key “o” can be measured and recorded over a number of trials. This can be done for various pairs of keys over a number of trials. Across all trails, statistical distributions can be calculated. Also the key holding duration distributions can be collected and calculated too.

The biometric analysis 364 can also be used as a security tool and be incorporated into Web site 322. The Web site 322 can decide the security levels, which are associated with different levels of pattern similarity. The Web site 322 or Web site manager can determine how many attempts are allowed for a user 320 to try to log in before a message is sent to the Web site 322 and/or the Web site 322 gets shut down.

Other options are also possible. For example, when the keystroke time sequence 364 for a particular user 320 is stored in the verifier 328 and statistical characteristics of typing are know, a user 320 is invited to type the same set of information that has been trained in the training phase. Then the user 320 submits the form with along with the captured keystroke time sequence 364. The application login time sequence can be processed into time intervals. Then based on the known statistical characteristics calculated from the training data and the security level, verifier 328 can compare the login time intervals with the distributions to see if the values fall into acceptable statistical areas. Then, based on the results of the comparisons, a decision either accepting or rejecting the user 320 can be made.

When a Web user 320 fills out a form on a vendor's Web site 322, user 320 must at least type some information for authentication purpose. The information could be first name, last name or anything desired. The biometric keystroke authentication 364 can work with any typing information as long as typing occurs. So an increased level of security can be achieved by capturing the user's 320 typing style and comparing it with previously stored training statistics. All this is done without increasing a user's 310 burden of supplying extra sensitive data, or any additional information. Also, the biometric analysis 364 relieves the vendor or Web site 322 of the burden of asking a user 320 for private information that may result in losing customers. Although it requires initial training, the ergonomically designed one-time training process takes very little effort and does not require privacy sensitive information.

Additionally, the biometric analysis 364 can use Web technology and not require any software installation by a user 320 and can be made compatible with all platforms (Microsoft Windows, Apple, Unix, Linux, etc.) and all Web browsers (e.g., all versions of IE, Netscape and AOL).

It should be understood that each of the added features of checking identification, that is, the features of checking identification by e-signature 362 and biometric analysis 364 and GID number 16, can be used as a stand alone identification check that is independent of the use of other information of the system 10. In other words, an identification check using only one tool can be performed. For example, one of the GID number 16, the e-signature 362, or the biometric analysis 364 could be the only tool used to verify identity. Alternatively, various combinations of checking can be used. For example, both the e-signature 362 check and the biometric analysis 364 check can be used together but without the use of the identification information 360 supplied by the user 310. Of course, in such cases where the identification information 360 supplied by the user 310 is not required or received, the accessing of the government and/or public databases would not be necessary since the e-signature check and the biometric analysis check are make against a previously received e-signature and/or biometric analysis of the user 310.

It should be understood that interconnections between the various elements of the various systems described herein are interchangeable with respect to the connections between other elements of the same system or between the same elements or between different elements of different systems. For example, even thought the preferred manner of transmitting the user information 16 in system 28, illustrated in FIG. 2 is by the Internet 32, the GID number 16 can be transferred to the analyzer 18 in any of the acceptable methods disclosed in any of the other embodiments, whether the other acceptable transfer method was between the user 12 and the analyzer 18 or between the establishment 54 and the analyzer 18. Thus, the user 12 of system 50 could forward the GID number 16 directly to the analyzer 18 by facsimile. The GID number 16 would then be manually typed by the analyzer manager directly to the analyzer 18. Additionally, as an example, even though some embodiments may indicate that the connection between the analyzer 18 and the database of algorithms 20 may be by Internet connection while others indicate a direct connection without use of the Internet, it should be understood any of the type of connections could be employed in any of the systems, and especially in any of the interconnections between the analyzer 18 and the database 20 in any of the embodiments herein.

It should further be understood that although the term “user” has been employed thorough out the specification, the user can be a single individual, a group of individuals, an entity such as a company, or any other individual or group or entity that would make us of the embodiments of the subject invention.

It should further be understood that in any of the embodiments described above, the users 12, 112, and 320 can be either remote from the requested goods and services and/or from the analyzer 18 or verifier 328 or local, non-remote users that are physically located with the requested goods and services and/or with the analyzer 18 or verifier 328.

The processing performed by each of the methods, systems, and devices described in the subject application may be performed by a general purpose computer alone or in connection with a specialized computer. Such processing may be performed by a single platform or by a distributed processing platform. In addition, such processing and functionality can be implemented in the form of special purpose hardware or in the form of software being run by a general purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

While the invention has been described with reference to the certain illustrated embodiments, the words which have been used herein are words of description, rather than words or limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and materials, such as are within the scope of the appended claims.

What is claimed is:

1. A method of verifying information comprising:
receiving a government identification number sent by a remote user via a user information vehicle to a local analyzer, the remote user being interested in obtaining services or products, the government identification number containing decipherable information regarding the identity of the remote user;
analyzing the government identification number including,
determining the issuing jurisdiction of the government identification number,
deciphering information from the government identification number, and
verifying the validity of the government identification number; and
notifying the remote user of the results of the verification of the government identification number and permitting or denying access to the remote user for the remote user-desired services or goods.

2. A method according to claim 1, wherein
the receiving a government identification number sent by a remote user via a user information vehicle to a local analyzer includes receiving a government identification number sent by a remote computer via the Internet to a local computer.

3. A method according to claim 2, wherein
the permitting or denying access to the remote user for the remote user-desired services or goods includes permitting the remote user to access an Internet Web site.

4. A method according to claim 2, wherein
the permitting or denying access to the remote user for the remote user-desired services or goods includes permitting the remote user to receive government-restricted goods.

5. A method according to claim 1, wherein
the receiving a government identification number sent by a remote user via a user information vehicle to a local analyzer includes receiving a government identification number sent by postal mail via a postal mail delivery system to a local analyzer.

6. A method according to claim 1, wherein
the receiving a government identification number sent by a remote user via a user information vehicle to a local analyzer includes receiving a government identification number sent by telephone call via a telephone call delivery system to a local analyzer.

7. A computer-readable medium encoded with a program for verifying information, said program comprising:
receiving a government identification number sent by a remote user via a user information vehicle to a local analyzer, the remote user being interested in obtaining services or products, the government identification number containing decipherable information regarding the identity of the remote user;
analyzing the government identification number including,
determining the issuing jurisdiction of the government identification number,
applying an issuing jurisdiction algorithm to the government identification number to decipher information from the government identification number, and
verifying the validity of the government identification number; and
notifying the remote user of the results of the verification of the government identification number and permitting or denying access to the remote user for the remote user-desired services or goods.

8. A medium according to claim 7, wherein
the receiving a government identification number sent by a remote user via a user information vehicle to a local analyzer includes receiving a government identification number sent by a remote computer via the Internet to a local computer.

9. A medium according to claim 8, wherein
the permitting or denying access to the remote user for the remote user-desired services or goods includes permitting the remote user to access an Internet Web site.

10. A medium according to claim 8, wherein
the permitting or denying access to the remote user for the remote user-desired services or goods includes permitting the remote user to receive government-restricted goods.

11. A method of verifying information comprising:
receiving user-supplied information from a user interested in obtaining services or products, the user-supplied information including:
a user government identification number containing decipherable information regarding the identity of the user, and
additional user identifying information;
analyzing the government identification number including,
determining the issuing jurisdiction of the government identification number,
deciphering information from the government identification number, and
verifying the validity of the government identification number;
retrieving confirming-information from a database relevant to the user-supplied information;
comparing the confirming-information to the user-supplied information to verify the accuracy of the user-supplied information; and
permitting or denying access to the user for the user-desired services or goods.

12. A method according to claim 11, wherein
the receiving user-supplied information from a user interested in obtaining services or products includes receiving user-supplied information via the Internet.

13. A method according to claim 12, wherein
the permitting or denying access to the user for the user-desired services or goods includes permitting or denying access to an Internet Website.

14. A method according to claim 12, wherein
the permitting or denying access to the user for the user-desired services or goods includes permitting or denying access to a government-restricted item.

15. A method according to claim 11, wherein
the receiving user-supplied information from a user interested in obtaining services or products includes receiving user-supplied information via a postal mail delivery system.

16. A method according to claim 11, wherein
the receiving user-supplied information from a user interested in obtaining services or products includes receiving user-supplied information via a telephone call delivery system.

17. A method according to claim 11, wherein
the receiving user-supplied information from a user interested in obtaining services or products includes receiving user-supplied information directly and in-person from the user, which is then, subsequently, entered into a computer system.

18. A method according to claim 11, further comprising:
forwarding a confirmation to the user confirming the user's desire to proceed with accessing the user-desired services or goods.

19. A method according to claim 11, further comprising:
retrieving user financial credit information from a credit database; and
analyzing the retrieved financial credit information to permit or deny access to the user for the user-desired services or goods.

20. A method according to claim 11, further comprising:
comparing the confirming-information to the deciphered information from the government identification number to further verify the identity of the user.

21. A method according to claim 11, wherein
the deciphering information from the government identification number includes applying an issuing jurisdiction algorithm to the government identification.

22. A method according to claim 1, wherein
the deciphering information from the government identification number includes applying an issuing jurisdiction algorithm to the government identification.

23. A method according to claim 11, wherein
the retrieving confirming information from a database relevant to the user-supplied information includes retrieving information from a government database.

24. A computer-readable medium encoded with a program for verifying information, said program comprising:
receiving user-supplied information from a user interested in obtaining services or products, the user-supplied information including:
a user government identification number containing decipherable information regarding the identity of the user, and
additional user identifying information;
analyzing the government identification number including,
determining the issuing jurisdiction of the government identification number,
deciphering information from the government identification number, and
verifying the validity of the government identification number;
retrieving confirming-information from a database relevant to the user-supplied information;
comparing the confirming-information to the user-supplied information to verify the accuracy of the user-supplied information; and
permitting or denying access to the user for the user-desired services or goods.

25. A medium according to claim 24, wherein
the receiving user-supplied information from a user interested in obtaining services or products includes receiving user-supplied information via the Internet.

26. A medium according to claim 24, wherein
the permitting or denying access to the user for the user-desired services or goods includes permitting or denying access to an Internet Website.

27. A medium according to claim 24, wherein
the permitting or denying access to the user for the user-desired services or goods includes permitting or denying access to a government-restricted item.

28. A medium according to claim 24, further comprising:
forwarding a confirmation to the user confirming the user's desire to proceed with accessing the user-desired services or goods.

29. A medium according to claim 24, further comprising:
retrieving user financial credit information from a credit database; and
analyzing the retrieved financial credit information to permit or deny access to the user for the user-desired services or goods.

30. A medium according to claim 24, further comprising:
comparing the confirming-information to the deciphered information from the government identification number to further verify the identity of the user.

31. A medium according to claim 24, wherein
the deciphering information from the government identification number includes applying an issuing jurisdiction algorithm to the government identification.

32. A medium according to claim 7, wherein
the deciphering information from the government identification number includes applying an issuing jurisdiction algorithm to the government identification.

33. A medium according to claim 24, wherein
the retrieving confirming-information from a database relevant to the user-supplied information includes retrieving information from a government database.

34. A method of verifying information comprising:
receiving user-supplied information from a user interested in obtaining services or products, the user-supplied information including:
a user government identification number containing decipherable information regarding the identity of the user, and
additional user identifying information;
analyzing the government identification number including,
determining the issuing jurisdiction of the government identification number,
deciphering information from the government identification number, and
verifying the validity of the government identification number;
retrieving confirming-information from a database relevant to the user-supplied information;
comparing the confirming-information to the deciphered information from the government identification number to further verify the identity of the user; and
permitting or denying access to the user for the user-desired services or goods.

35. A computer-readable medium encoded with a program for verifying information, said program comprising:
receiving user-supplied information from a user interested in obtaining services or products, the user-supplied information including:
a user government identification number containing decipherable information regarding the identity of the user, and
additional user identifying information;
analyzing the government identification number including,
determining the issuing jurisdiction of the government identification number,
deciphering information from the government identification number, and
verifying the validity of the government identification number;
retrieving confirming-information from a database relevant to the user-supplied information;
comparing the confirming-information to the deciphered information from the government identification number to further verify the identity of the user; and
permitting or denying access to the user for the user-desired services or goods.

36. A method of verifying information comprising:
receiving identifying information from a user interested in obtaining information from an Internet Web site;
receiving information on the user from a government identification number;
determining whether the user is qualified to access the Internet Web site by comparing the information received regarding the user against predetermined standards for obtaining the desired information; and
notifying the Internet Web site of the results of the determination of the user's qualification.

37. A computer-readable medium encoded with a program for verifying information, said program comprising:
receiving identifying information from a user interested in obtaining information from an Internet Web site;
receiving information on the user from a government identification number;
determining whether the user is qualified to access the Internet Web site by comparing the information received regarding the user against predetermined standards for obtaining the desired information; and
notifying the Internet Web site of the results of the determination of the user's qualification.

38. A method according to claim 11, wherein
the receiving user-supplied information includes receiving an electronic signature from the user.

39. A medium according to claim 24, wherein
the receiving user-supplied information includes receiving an electronic signature from the user.

40. A method according to claim 11, wherein
the receiving user-supplied information includes receiving keyboard biometric information from the user.

41. A medium according to claim 24, wherein
the receiving user-supplied information includes receiving keyboard biometric information from the user.
